(19) United States
(12) Patent Application Publication
(10) Pub. No.: US 2025/0205018 A1
(43) Pub. Date: Jun. 26, 2025

(54) CONVERTIBLE DENTAL AUXILIARIES

(71) Applicant: Align Technology, Inc., San Jose, CA (US)

(72) Inventors: Mitra DERAKHSHAN, Herndon, VA (US); John Y. MORTON, San Jose, CA (US); Ryan KIMURA, San Jose, CA (US); Jun SATO, San Jose, CA (US)

(21) Appl. No.: 18/990,964

(22) Filed: Dec. 20, 2024

Related U.S. Application Data
(60) Provisional application No. 63/614,513, filed on Dec. 22, 2023.

(51) Int. Cl. A61C 7/22; A61C 13/00

(52) U.S. Cl. CPC A61C 7/22; A61C 13/0006

(57) ABSTRACT

Methods and apparatuses (e.g., devices, system, etc., including software, hardware and firmware) including convertible dental auxiliary devices and methods of making and using them. The convertible dental auxiliary devices described herein may convert between two or more different stable configurations that may be useful to engage with one or more patient-removable dental appliances and/or one or more orthodontic force accessories.

### CLAIM OF PRIORITY

This patent application claims priority to U.S. provisional patent application No. 63/614,513, titled “CONVERTIBLE DENTAL AUXILIARIES,” and filed on Dec. 22, 2023, herein incorporated by reference in its entirety.

### BACKGROUND

Orthodontic procedures may include repositioning a patient's teeth to a desired arrangement in order to correct malocclusions and/or improve aesthetics. To achieve these objectives, orthodontic appliances such as braces, shell aligners, and the like can be applied to the patient's teeth by an orthodontic practitioner. The appliance can be configured to exert force on one or more teeth in order to effect desired tooth movements according to a treatment plan.

Braces may be attached, e.g., bonded, to a patient's teeth using one or more brackets that are connected by wires. In contrast, patient-removable dental appliances, such as shell aligners, may be applied over the patient's teeth and may removably engage the patient's teeth. In some cases, one or more auxiliary devices, such as attachments, may be bonded to the teeth and may be used to help engage with the patient-removably dental appliance. In some cases it may be beneficial to use a hybrid approach, in which force may be applied to the patient's teeth and/or dental arch by both patient-removable dental appliances and by one or more backet (or bracket-like) structures. Described herein are dental auxiliary structures, e.g., hybrid dental auxiliary structures, which may convert between one or more configurations for engaging with a patient-removable dental appliance and one or more orthodontic force accessories (e.g., wires, hooks, arms, etc.).

### SUMMARY OF THE DISCLOSURE

Described herein are methods and apparatuses (e.g., devices, system, etc., including software, hardware and firmware) including convertible dental auxiliary devices and methods of making and using them. Dental auxiliaries may include dental attachments, dental brackets, etc., and are typically bonded to a patient's teeth in order to provide grip and leverage in order to apply force(s) to move the teeth or, in some examples, teeth and/or jaw (e.g., palate). In some examples dental auxiliaries may be used with one or more, e.g., a series of patient-removable dental appliances such as an orthodontic aligner, retainer, palatal expander, lower arch expander, etc. The patient-removable dental appliance may include a shell appliance that includes one or more cavities for receiving the patient's teeth. A dental auxiliary may engage with the dental appliance through one or more engagement surface that engages with a region, such as a cavity, on an inside surface of the dental appliance. The dental auxiliary may otherwise provide a relatively smooth, low profile to avoid irritating the patient's tongue and lips while allowing the dental appliance to be easily removed and attached. The dental auxiliary may have an unbroken outer surface, which may also avoid small openings, channels or crevasses that may trap food and/or may lead to bacterial growth. However, in some cases it may also be useful to provide one or more structures, including channels, frames, arms, etc. that may include and/or may securely anchor to an orthodontic force accessory (e.g., wires, arms, etc.). Thus it may be particularly useful and helpful, e.g., reducing treatment time and improving patient outcomes, to provide one or more dental auxiliary devices that may include channels, openings, arms, frames, forks, prongs, etc., that may be used to apply additional force through the dental auxiliary to the tooth or teeth, in a manner that overcomes or minimizes the risks and disadvantages including irritation patient tissues and enhanced bacterial growth. Described herein are convertible dental auxiliary devices that may reduce or eliminate these risks and disadvantages. In particular, described herein are convertible dental auxiliary devices that may convert between a first configuration that is specifically adapted for use with a patient-removable dental appliance (e.g., an “attachment” configuration), and a second configuration that is specifically adapted to include or facilitate the attachment of an orthodontic force accessory, such as a wire, arm (e.g., hook), or the like. In general these convertible dental auxiliary devices may include a first configuration in which the external profile of the convertible dental auxiliary device is relatively smooth and unbroken, and is adapted for engaging with one or more dental appliances. In some cases the external surface of the convertible dental auxiliary devices in the first configuration may be sealed, covered or otherwise enclosed, and may include a body region having at least one engagement surface. The second (or more) configurations of the convertible dental auxiliary device may include a wire attachment channel, opening or opening and/or may expose or engage an orthodontic force accessory within this channel.

For example, described herein are convertible dental auxiliary devices that include: a tooth-bonding surface configured to be bonded to a tooth surface; and a body region extending from the tooth-bonding surface, wherein the body region comprises a channel extending at least partially through the body region and a channel opening configured to receive an orthodontic force accessory, such as a wire or arm, within the channel, wherein the body region is convertible between a first configuration and a second configuration, wherein the channel opening is open in the first configuration, and wherein the channel opening is closed in the second configuration.

In some examples, in the second configuration, the body region forms an engagement surface for engaging a receiving region of a dental appliance when the dental appliance is worn on a patient's teeth, wherein the dental appliance comprises a shell having one or more cavities for receiving one or more teeth of the patient. As mentioned, the dental appliance may include any patient-removable dental appliance, such as an aligner, a retainer, an upper arch expander, a palatal expander, a lower arch expander, etc.

In some examples the device may include a removable material held within the channel in the second configuration. The removable material may be removed from the channel and from the device. In some examples the removable material may be removed from the channel and retained by the device (e.g., moved out of the channel but may remain attached to the channel).

Any of these apparatuses may cover configured to cover the channel opening in the second configuration. In some examples the cover may be removable from over the channel opening. The cover may be fully removable and separable from the device. In some examples the cover is movably coupled to the device, such as hinged to the device. In some cases the cover comprise a penetrable material that is configured to be pierced to provide access to the channel. The penetrable material may be an elastomeric material. In some examples the penetrable material comprises a low-durometer, biocompatible polymer, such as a silicone, polyurethane, etc. In some examples the penetrable material may allow for multiple penetrations that may self-close (e.g., “heal”) when the orthodontic force accessory is removed, converting the device back into the first configuration.

As mentioned the orthodontic force accessory may comprise any appropriate structure that may be extended from and/or coupled to the channel. In some examples the orthodontic force accessory may comprise an arm, such as a ‘power arm’ that may include a hook or other engager for engaging a force-applying member, such as an elastic (e.g., rubber band, etc.) to apply force to the teeth through the device. In some examples the channel is configured to secure a power arm.

In general, the channels of the convertible dental auxiliary devices described herein may include one or more channels at least partially through the body of the device (e.g., the body region). The one or more channels may be straight or curved. The one or more channels may be oriented in any appropriate manner. For example, the one or more channels may be vertical, horizontal or virtually any angle relative to the patient's teeth when worn (e.g., relative to the buccal or lingual surface to which the device is bonded). The channel may be parallel to the tooth-bonding surface. In some examples the channel may be proclined or retroclined. The channel may be entirely or partially enclosed. For example, the channel may comprise a vertical slot, a horizontal slot or a slot angled between the horizontal and vertical. The inner diameter of the channel may be constant, or it may be variable. In some examples the inner diameter of the channel tapers along the length, so that it is wider at the opening(s). In some examples the channel is wider at an open end and narrower at the second end of the channel, which may be opened or closed.

In some examples, the convertible dental auxiliary device is configured so that the outer profile (e.g., shape) and/or orientation of the dental auxiliary device is changed when converting between the first configuration and the second (or more) additional configurations. This may allow for the convertible dental auxiliary device to engage differently with different patient-removable dental appliances without having to remove the convertible dental auxiliary device.

In some examples a convertible dental auxiliary device may include: a tooth-bonding surface configured to be bonded to a tooth surface; and a body region extending from the tooth-bonding surface, wherein the body region comprises one or more protrusions forming a first contact profile in a first configuration, and a second configuration comprising a second contact profile that is different from the first contact profile, wherein the first contact profile is configured to engage with a receiving region of one or more patient-removable dental appliances when the one or more dental appliances is worn on a patient's teeth, further wherein the body region is convertible between the first configuration and the second configuration by moving the one or more protrusions relative to the tooth bonding surface.

In some examples the second contact profile may be configured to extend from the body of the convertible dental auxiliary device and/or may contact and engage with a force-applying element, such as an elastic. For example, the second contact profile may be configured to include an arm and/or hook, a wing, etc. Thus the orthodontic force accessory may be integrated into the convertible dental auxiliary device and may be exposed by converting the convertible dental auxiliary device from the first configuration to the second configuration.

The first contact profile may include a first engagement surface that is configured to engage a receiving region of a dental appliance when the dental appliance is worn on a patient's teeth. The first contact profile may be configured to engage a receiving region of a first dental appliance when the first dental appliance is worn on a patient's teeth and wherein the second contact profile is configured to engage a receiving region of a second dental appliance when the second dental appliance is worn on the patient's teeth.

In some examples the first contact profile comprises a first engagement surface having a first contact angle in the first configuration and wherein the second contact profile comprises a second engagement surface having a second contact angle in that is different from the first contact angle.

Any of these convertible dental auxiliary devices may include a cover covering the one or more protrusions. The cover may be a soft, deformable (e.g., low-durometer) material that may deform as the one or more protrusions change configuration. Any of these convertible dental auxiliary devices may include a movable joint, such as a hinge or pivot, which is configured to allow movement of the one or more protrusions to convert between the first configuration and the second configuration.

The convertible dental auxiliary devices may be configured to hold the device in any of these configurations. For example, any of these devices may include a releasable lock or latch that is configured to secure the one or more protrusions in the first configuration and/or the second configuration.

A convertible dental auxiliary device may include: a tooth-bonding surface configured to be bonded to a tooth surface; and a body region extending from the tooth-bonding surface, wherein the body region comprises one or more protrusions having a first configuration comprising a first contact profile, and a second configuration wherein the contact profile has a different shape and/or different orientation relative to the first configuration, wherein, in the first configuration the contact profile is configured to engage with a receiving region of one or more patient-removable dental appliances when the one or more dental appliances is worn on a patient's teeth, further wherein the body region is convertible between the first configuration and the second configuration by moving the one or more protrusions relative to the tooth bonding surface.

A convertible dental auxiliary device may include a pivot joint between the protrusion and the tooth-bonding surface configured to change the orientation between the first configuration and the second configuration. For example, in the second configuration the second contact profile may be configured as an arm and/or hook extending from the body region.

Also described herein are systems including any of the convertible dental auxiliary devices described herein. These systems may include one or more orthodontic force accessories, and/or one or more patient-removable dental appliances. For example, a system may include: a convertible dental auxiliary device comprising: a tooth-bonding surface configured to be bonded to a tooth surface; and a body region extending from the tooth-bonding surface, wherein the body region comprises a channel extending at least partially through the body region and a channel opening configured to receive an orthodontic force accessory within the channel, wherein the body region is convertible between a first configuration and a second configuration, wherein the channel opening is closed in the first configuration, and wherein the channel opening is open in the second configuration; one or more dental appliances each comprising a receiving region that is configured to engage with an engagement surface of the body region when the body region is in the first configuration; and an orthodontic force accessory that is configured to be received by the channel of the convertible dental auxiliary device in the second configuration.

As mentioned, any appropriate patient-removable dental appliance may be used, including one or more of: an aligner, an upper arch expander, a palatal expander, a lower arch expander, a retainer, etc. The system may include one or more patient-removable dental appliances. For example, any of these apparatuses may include one or more second dental appliances configured to be worn on the subject's teeth when the convertible dental appliance is in the second configuration.

Any of these convertible dental auxiliary devices may be configured to convert to different orientations after they have been bonded to a tooth. For example, a convertible dental auxiliary device may include: a tooth-bonding surface configured to be bonded to a tooth surface; and a body region coupled to and extending from the tooth-bonding surface, wherein the body region comprises an engagement surface configured to engage with an orthodontic appliance (e.g., aligner, retainer, palatal expander, etc.) and a lock, wherein the body region is convertible between a first configuration, in which the engagement surface has a first orientation relative to the tooth-bonding surface, and a second configuration, having a second orientation relative to the tooth-bonding surface, by disengaging the lock and moving the body region relative to the tooth bonding surface, and re-engaging the lock.

The lock may comprise a bias, e.g., a spring. In any of these devices the interface between the tooth-bonding surface and the body region may be a sawtooth surface, and/or may be otherwise configured to lockingly engage.

In any of these apparatuses the second orientation of the engagement surface may have a greater angle relative to the tooth-bonding region than the engagement surface in the first orientation. In some cases the engagement surface may be rotated in the plane of the tooth-bonding surface in the second orientation relative to the first orientation. Any of these devices may include a shim that is configured to be coupled between the body region and the tooth-bonding surface in the second orientation.

Also described herein are devices that are configured to convert by swapping out the portion of the device including the engagement surface. For example, a convertible dental auxiliary device may include: a tooth-bonding surface configured to be bonded to a tooth surface; and a first body region lockable coupled to and extending from the tooth-bonding surface, wherein the first body region comprises a first engagement surface configured to engage with an orthodontic appliance; and a lock, wherein the lock is configured to secure the first body region onto the base; and a second body region configured to be swapped for the first body region by unlocking the lock, removing the first body region and securing, by the lock, the second body region on the tooth-bonding surface, wherein the second body region comprises a second engagement surface that has a different orientation relative to the tooth-bonding surface than the first body region.

Also described herein are methods of treating a patient's teeth using any of these apparatuses (e.g., any of the convertible dental auxiliary devices) described herein. For example, any of these methods may include: converting a convertible dental auxiliary device that is bonded to patent's tooth from a first configuration to a second configuration or from a second configuration to a first configuration, wherein the first configuration comprises an engagement surface for engaging a receiving region of a dental appliance when the dental appliance is worn on the patient's teeth, wherein the dental appliance comprises a shell having one or more cavities for receiving one or more teeth of the patient, and wherein the convertible dental auxiliary device comprises one or more channels extending at least partially through a body of the convertible dental auxiliary device and a channel opening, further wherein the one or more openings are open in the second configuration and closed in the first configuration; and securing an orthodontic force accessory within the channel in the second configuration.

Any of these methods may optionally include bonding and/or attaching the convertible dental auxiliary device to the patient's tooth. Bonding the convertible dental auxiliary device to the tooth may include using a placement device (e.g., jig, frame, guide, etc.) to position the convertible dental auxiliary device on the tooth in a predetermined position, which may be part of a treatment plan. For example, the method may include attaching a tooth-bonding surface of a convertible dental auxiliary device to the patient's teeth. As used herein, bonding may include any appropriate attachment to the tooth or teeth including, but not limited to, the use of a crosslinking material to secure the convertible dental auxiliary to tooth or teeth.

In general, these methods may include applying force to the patient's teeth through the convertible dental auxiliary device in either or both the first and second configurations. For example, the method may include applying force to the patient's teeth from the orthodontic force accessory coupled to (or integral with) the convertible dental auxiliary device while the convertible dental auxiliary device is in the second configuration. This applied force may move one or more teeth, e.g., according to a treatment plan. The method may also or alternatively include applying force to the patient's teeth from a dental appliance that is engaged with the convertible dental auxiliary device while the convertible dental auxiliary device is in the first configuration. The dental appliance may apply force to move one or more teeth, e.g., according to the treatment plan.

In any of these methods converting may comprise removing a material from the channel to convert the convertible dental auxiliary device from the first configuration to the second configuration. In some cases the convertible dental auxiliary device may include multiple channels; the user, e.g., dental professional, may select which channel to remove material from and/or expose the opening into. In some examples converting comprises removing a cover from the channel, e.g., a selected channel, to convert the convertible dental auxiliary device from the first configuration to the second configuration. In some examples, converting comprises piercing a penetrable material covering the channel to convert the convertible dental auxiliary device from the first configuration to the second configuration. Piercing the penetrable cover may expose the channel (even in a limited manner) in the second configuration so that an orthodontic force accessory (e.g., wire, arm, etc.) may be inserted into the channel.

Any of these methods may include converting the convertible dental auxiliary device from the second configuration to the first configuration. In some examples the convertible dental auxiliary device may be switched between the first configuration and the second configuration multiple times, allowing treatment of the teeth to include the application of force from one or more orthodontic force accessories in some states and removable dental appliances (e.g., aligners, palatal expanders, arch expanders, etc.) in other stages.

In some cases the method may include securing the orthodontic force accessory within the channel by inserting the orthodontic force accessory, e.g., wire, arm, etc., through the one or more openings into the channel. The orthodontic force accessory may be locked or secured in the channel. In some cases the orthodontic force accessory may include a locking region, e.g., clip, detent, etc. to releasably retain the orthodontic force accessory within the channel. In some cases the channel may be configured to releasably retain the orthodontic force accessory within the channel.

Also described herein are methods for generating an orthodontic treatment plan for a patient that include the use of one or more convertible dental auxiliary devices. As mentioned, these convertible dental auxiliary device may allow dental treatment plans that advantageously allow force to be applied both through one or more removable dental appliances that engage with the convertible dental auxiliary device, but they may also allow the application of force through the same convertible dental auxiliary device due to one or more orthodontic force accessories. For example, a method of generating an orthodontic treatment plan may include: determining a plurality of stages of the orthodontic treatment plan to move the patient's teeth from an initial configuration to a final configuration; identifying, as part of the orthodontic treatment plan, one or more patient-removable dental appliances to be worn over the patient's teeth during one or more stages of the plurality of stages; identifying, as part of the orthodontic treatment plan, a bonding site on the patient's teeth for one or more convertible dental auxiliary devices to separately operate in both a second configuration and a first configuration, wherein the one or more convertible dental auxiliary devices are coupled to an orthodontic force accessories to apply force to the patient's teeth while the one or more convertible dental auxiliary devices are operating in the second configuration, and wherein the one more convertible dental auxiliary devices are not coupled to the orthodontic force accessories and are engaged with a receiving region of a patient-removable dental appliance when the one or more convertible dental auxiliary devices are operating in the first configuration; and outputting the orthodontic treatment plan.

Any of these methods may include outputting one or more convertible dental auxiliary devices, a placement device (e.g., jig, frame, guide, etc.) to position the convertible dental auxiliary device(s), one or more orthodontic force accessories for placing a treatment device, and/or one or more dental appliances for engage the convertible dental appliances. In any of these methods, outputting the orthodontic treatment plan may include outputting a digital file for forming any of these devices. In any of these methods outputting the orthodontic treatment plan may include fabricating any of these devices, including, e.g., fabricating at least one of the one or more patient-removable dental appliances. In any of these methods outputting the orthodontic treatment plan may comprise fabricating at least one of the one or more convertible dental auxiliary devices and/or a template for holding the one or more convertible dental auxiliary devices in the identified bonding site.

In any of these examples, identifying the bonding site on the patient's teeth may include estimating a force applied by the one or more convertible dental auxiliary devices in the second configuration, and estimating the force applied by the one or more patient-removable dental appliances and the one or more convertible dental auxiliary devices in the first configuration. Because the convertible dental auxiliary device may remain bonded to the tooth in the same position when applying force both from the patient-removable dental appliances and from an orthodontic force accessory, these methods may optimize the proper position and orientation for the convertible dental auxiliary device across the treatment plan.

Any of these methods may also include identifying the one or more convertible dental auxiliary devices to be used (e.g., to apply a desired force to move one or more teeth) according to the treatment plan. The method may include selecting from a library (e.g., a digital database) of convertible dental auxiliary devices and/or orthodontic force accessories to be used with the convertible dental auxiliary devices. Alternatively or additionally, identifying the convertible dental auxiliary devices to be used may include designing the one or more convertible dental auxiliary devices and/or modifying the one or more convertible dental auxiliary devices from a preexisting design.

Any of these methods may include identifying which stage of the orthodontic treatment plan to convert the one or more convertible dental auxiliary devices from the second configuration to the first configuration and/or from the first configuration to the second configuration.

All of the methods and apparatuses described herein, in any combination, are herein contemplated and can be used to achieve the benefits as described herein.

### BRIEF DESCRIPTION OF THE DRAWINGS

A better understanding of the features and advantages of the methods and apparatuses described herein will be obtained by reference to the following detailed description that sets forth illustrative embodiments, and the accompanying drawings of which:

FIGS. 1A-1E illustrate one example of a convertible dental auxiliary device. FIG. 1A shows a convertible dental auxiliary device in a first configuration that is configured to engage with a corresponding receiving cavity of a patient-removable dental appliance (e.g., an aligner, a palatal expander) worn on a patient's teeth. FIG. 1B shows a top view of the convertible dental auxiliary device in a second configuration, including an open channel configured to receive an orthodontic force accessory, such as a wire or arm (e.g., hook). FIG. 1C shows the convertible dental auxiliary device of FIG. 1B with an example of an orthodontic force accessory within the open channel. FIG. 1D is a side perspective view of the convertible dental auxiliary device of FIG. 1A, in the first configuration. FIG. 1E is a side perspective view of the convertible dental auxiliary device of FIG. 1B, showing the second configuration of the convertible dental auxiliary device.

FIGS. 2A-2E illustrate an example of a convertible dental auxiliary device. FIG. 2A shows a top view of the convertible dental auxiliary device in a first configuration that is configured to engage with receiving cavity of a patient-removable dental appliance worn on a patient's teeth. FIG. 2B shows a top view of the convertible dental auxiliary device of FIG. 2A in a second configuration, including an open channel configured to receive an orthodontic force accessory. FIG. 2C shows the convertible dental auxiliary device of FIG. 2B with an example of an orthodontic force accessory, shown as a wire, within the open channel. FIG. 2D is a side perspective view of the convertible dental auxiliary device of FIG. 2A, in the first configuration. FIG. 2E is a side perspective view of the convertible dental auxiliary device of FIG. 2B, showing the second configuration of the convertible dental auxiliary device.

FIGS. 2F and 2G illustrate an example of a convertible dental auxiliary device similar to that shown in FIGS. 2A-2E, attached to a tooth. FIG. 2F shows the convertible dental auxiliary device in a first configuration, engaging receiving cavity of a patient-removable dental appliance worn on a patient's teeth. FIG. 2G shows the convertible dental auxiliary device in the second configuration, with a wire extending through the exposed channel of the convertible dental auxiliary device.

FIGS. 3A-3F illustrate an example of a convertible dental auxiliary device having a plurality of channels. FIG. 3A shows a top view of the convertible dental auxiliary device in a first configuration that is configured to engage with receiving cavity of a patient-removable dental appliance worn on a patient's teeth. FIG. 3B shows a top view of the convertible dental auxiliary device of FIG. 3A in a second configuration, including a plurality of open channels configured to receive an orthodontic force accessory (in some examples only one of these channels may be exposed). FIG. 3C shows the convertible dental auxiliary device of FIG. 3B with an example of an orthodontic force accessory, shown as an arm (including a hook region), within one of the open channels. FIG. 3D is a side perspective view of the convertible dental auxiliary device of FIG. 3A, in the first configuration. FIG. 3E is a side perspective view of the convertible dental auxiliary device of FIG. 3B, showing the second configuration of the convertible dental auxiliary device. FIG. 3F illustrates an example of the convertible dental auxiliary device with only one of the channels used to hold an orthodontic force accessory (e.g., an arm).

FIGS. 4A-4D illustrate another example of a convertible dental auxiliary device having a cover (e.g., an elastomeric cover) over the convertible dental auxiliary device that may cover one or more channels in a first configuration; these channels may hold one or more orthodontic force accessories in the second configuration. FIG. 4A shows a top view of the convertible dental auxiliary device in the first configuration, in which the one or more channels are covered. FIG. 4B shows insertion of an orthodontic force accessory into a channel of the convertible dental auxiliary device that is covered by a cover that may be penetrated to by the orthodontic force accessory to convert the convertible dental auxiliary device to the second configuration. FIG. 4C shows the convertible dental auxiliary device in the second configuration, in which the internal channel of the convertible dental auxiliary device is holding an orthodontic force accessory (e.g., shown as a wire in this example). FIG. 4D shows a side perspective view of the convertible dental auxiliary device of FIG. 4A in the first configuration.

FIGS. 5A-5B illustrate an example of a convertible dental auxiliary device having a cover similar to that shown in FIGS. 4A-4D. In FIG. 5A the convertible dental auxiliary device includes a cover (e.g., a penetrable cover, such as an elastomeric cover). FIG. 5B shows the convertible dental auxiliary device of FIG. 5A in the second configuration, with an orthodontic force accessory (e.g., arm) extending through the cover and one of the internal channels.

FIG. 5C illustrates an alternative example of a convertible dental auxiliary device having channels that are configured to hold a convertible dental auxiliary device in a predetermined orientation.

FIG. 5D shows an example of a convertible dental auxiliary device that may be used with any of the convertible dental auxiliary devices described herein, including the example shown in FIG. 5C.

FIGS. 6A-6D illustrate one example of a convertible dental auxiliary device attached to a tooth and operating in a first configuration (engaging with a dental appliance) and a second configuration (e.g., engaged with an orthodontic force accessory). FIG. 6A shows the convertible dental auxiliary device bonded to a tooth. FIG. 6B shows the convertible dental auxiliary device engaged within a receiving region (e.g., cavity) of a dental appliance so that an engagement surface of the convertible dental auxiliary device engages with the dental appliance. FIG. 6C shows the convertible dental auxiliary device in the second configuration, with an orthodontic force accessory, configured as an arm including a hook, extending stably from the convertible dental auxiliary device. FIG. 6D shows another example of a pair of convertible dental auxiliary devices, each bonded to a tooth and including an orthodontic force accessory that engages with a force-applying bias (e.g., elastic band).

FIGS. 7A-7E illustrate another example of a convertible dental auxiliary device that may be converted from a first configuration for engaging with a dental appliance, and into a second configuration including a channel for securing an orthodontic force accessory to the convertible dental auxiliary device. FIG. 7A shows a top view of the convertible dental auxiliary device in a first configuration, having a relatively smooth and continuous outer surface. FIG. 7B illustrates conversion of the convertible dental auxiliary device of FIG. 7A from the first configuration to the second configuration having an exposed channel for holding an orthodontic force accessory. FIG. 7C shows a side perspective view of the convertible dental auxiliary device of FIG. 7A. FIG. 7D is a side perspective view of the convertible dental auxiliary device of FIG. 7B, showing the channel to receive an orthodontic force accessory. FIG. 7E shows a side perspective view similar to that shown in FIG. 7D but with an orthodontic force accessory within the exposed channel.

FIGS. 7F and 7G illustrate an example of a convertible dental auxiliary device including a cover or lid. The convertible dental auxiliary device may be similar to the example shown in FIGS. 2A-2E, 3A-3F, 4A-4F, and/or 7A-7E but may include the protective lid as well.

FIGS. 8A-8B illustrate one example of a convertible dental auxiliary device including an extendable protrusion (configured as a hinged hook structure in FIGS. 8A-8B) that may be included with any of the convertible dental auxiliary devices described herein. FIG. 8A shows the convertible dental auxiliary device in a first configuration with an engagement surface exposed for engaging with a dental appliance. FIG. 8B shows the convertible dental auxiliary device in a second configuration with a protrusion extended outwards, forming an attached orthodontic force accessory (e.g., hook).

FIGS. 9A-9B illustrate an example of a convertible dental auxiliary device including expanders configured to change the width of the convertible dental auxiliary device. FIG. 9A shows the convertible dental auxiliary device with the expanders fully retracted, in the narrow configuration, while FIG. 9B shows the convertible dental auxiliary device with the expanders expanded fully.

FIGS. 10A-10F illustrate another example of a convertible dental auxiliary device comprising a protrusion region that may be adjusted to adjust the location and/or orientation of the engagement surface of the convertible dental auxiliary device. In the top view of FIG. 10A the convertible dental auxiliary device is shown in a first configuration having a protrusion in a first orientation. FIG. 10B shows the convertible dental auxiliary device of FIG. 10A in a second configuration in which the protrusion is shown in a second orientation. FIG. 10C shows the convertible dental auxiliary device of FIGS. 10A-10B in a third configuration in which the protrusion is in a third orientation. FIGS. 10D-10F show side perspective views of the convertible dental auxiliary device of FIGS. 10A-10C, respectively.

FIGS. 11A-11B illustrate an example of a convertible dental auxiliary device that is configured to change the linear position (e.g. slide up/down) relative to the tooth. FIG. 11A shows the convertible dental auxiliary device in a first position when bonded to the tooth and FIG. 11B shows the same convertible dental auxiliary device in a second position, linearly displaced (“up” in FIG. 11B) relative to the base that is bonded to the tooth.

FIG. 11C shows another example of a convertible dental auxiliary device configured to adjust its lateral position relative to a tooth.

FIGS. 12A-12B illustrate an example of a convertible dental auxiliary device configured to change an angle relative to the tooth without requiring de-bonding and reattaching of the device to the tooth. FIG. 12A shows the device in a first configuration and FIG. 12B shows the device in a second configuration having a different angle.

FIGS. 12C-12E illustrate an example of a convertible dental auxiliary device configured to change an angle relative to the tooth without requiring de-bonding and reattaching of the device to the tooth.

FIGS. 13A-13C schematically illustrate another example of a convertible dental auxiliary device that may be converted from a first configuration for engaging with a dental appliance, and into a second configuration including a channel for securing an orthodontic force accessory. FIG. 13A shows a top view in a first configuration; FIGS. 13B shows a top view in a second configuration; and FIG. 13C shows a side configuration.

FIG. 14 schematically illustrates one example of a method of using a convertible dental auxiliary device.

FIG. 15 schematically illustrates an example of a method of generating an orthodontic treatment plan for a patient including one or more convertible dental auxiliary devices as described herein.

### DETAILED DESCRIPTION

The convertible dental auxiliary devices described herein may convert between two or more different stable configurations that may be useful to engage with one or more patient-removable dental appliances and/or one or more orthodontic force accessories. Thus, these devices may advantageously apply different forces through the same attachment region on a tooth, without requiring the removal of the dental auxiliary device that may otherwise be necessary.

In some examples these convertible dental auxiliary devices may be pre-formed or fabricated in one or more sizes and/or shapes, and may be selected for use depending on the patient and/or user needs. In some cases the convertible dental auxiliary devices may be directly printed or fabricated and may be compatible with one or more orthodontic force accessories, such as but not limited to wires, arms (e.g. power arms) and/or hooks, elastic bands, etc.

These convertible dental auxiliary device may be configured to be compatible with both patient-removable dental appliances, such as shell appliances that are worn over the teeth, as well as with wire-and-bracket systems that may use wires to control tooth movement, including for extrusion, rotation, root up-righting, etc. In some cases the convertible dental auxiliary devices are configured to engage an orthodontic force accessory that is part of a wire-and-bracket system. For example, a convertible dental auxiliary device may include an attachment (e.g., channel) for one or more wires to be slotted though, e.g., vertically (for control of root movement), horizontally (e.g., for rotation of a tooth or vertical, intrusion and extrusion), etc.

In some examples the convertible dental auxiliary device is configured to form or engage an orthodontic force accessory such as a power arm, which may be used with one or more force-applying elements, such as elastic bands.

Thus the convertible dental auxiliary devices described herein may enable a hybrid orthodontic treatment, and may easily and quickly make treatment with patient-removable dental appliances (e.g., aligner treatment) compatible with wire-attachment treatment, including allowing and facilitating switching between these treatment modes and/or combining these treatment modes, during the same treatment plan, as part of the same or different treatment stages.

The convertible dental auxiliary devices described herein may be configured to change shape to convert from a first configuration that engages with a patient-removable dental appliance, and a second configuration that engages with one or more orthodontic force accessories. The convertible dental auxiliary device may be configured to engage with one or more wires, arms and/or hooks (e.g., ‘power arms’), elastic bands, etc. In some examples the apparatus is configured to convert between a first configuration having a relatively smooth profile, which may prevent or minimize the undesirable capture of food particles and may reduce or prevent bacterial growth, and a second configuration including an opening into a channel into which an orthodontic force accessor is engaged or may be engaged. The convertible dental auxiliary device may be converted by the user (e.g., dental professional, such as a dentist, orthodontist, dental technician, etc.). In some examples the convertible dental auxiliary device may be converted by removing material or cover to expose a channel (e.g., passage, slot, etc.) or an opening into a channel that may be used to as a bracket or support to hold an orthodontic force accessory such as a wire, arm, etc. These convertible dental auxiliary devices may also be configured to convert from the second configuration to the first configuration, e.g., by removing/disengaging the orthodontic force accessory, and in some examples adding material or covering the channel opening and/or channel.

In some examples the convertible dental auxiliary device may be configured to alter the surface shape (e.g., profile), size, and/or orientation of the convertible dental auxiliary device, and in particular of the engagement region. For example, in some cases the convertible dental auxiliary device may include one or more protrusions that are configured to move, e.g., relative to the base of the convertible dental auxiliary device (e.g., the bonding surface of the convertible dental auxiliary device) to extend/retract to form more rounded and/or larger surface area contact surfaces for contacting a patient-removable dental appliance. The angle of the contact profile surface may be changed in this manner, and/or the contact surface may be changed by forming (or adding) an orthodontic force accessory (e.g., power arm).

The second configuration of the convertible dental auxiliary device may be used to apply force to the tooth to which the convertible dental auxiliary device is attached using one or more orthodontic force accessories that may couple to the convertible dental auxiliary device or may be integrally formed as part of the convertible dental auxiliary device. The channels through the body of the convertible dental auxiliary device, which may be accessible in the second configuration of the convertible dental auxiliary device, may be oriented when the convertible dental auxiliary device is bonded to a tooth to assist in applying force to the teeth. As mentioned, the one or more channels may be straight or curved. The one or more channels may be oriented in any appropriate manner. For example, the one or more channels may be vertical, horizontal, or virtually any angle relative to the patient's teeth when worn (e.g., relative to the buccal or lingual surface to which the device is bonded). The channel may be parallel to the tooth-bonding surface. In some examples the channel may be proclined or retroclined. The channel may be entirely or partially enclosed. For example, the channel may comprise a vertical slot, a horizontal slot, or a slot angled between the horizontal and vertical. The inner diameter of the channel may be constant, or it may be variable. In some examples the inner diameter of the channel tapers along the length, so that it is wider at the opening(s). In some examples the channel is wider at an open end and narrower at the second end of the channel, which may be opened or closed. The channel may have any appropriate cross-sectional shape, including, but not limited to, round, oval, rectangular, semi-circular, etc. Similarly, the opening(s) into the channel may be any appropriate shape or size.

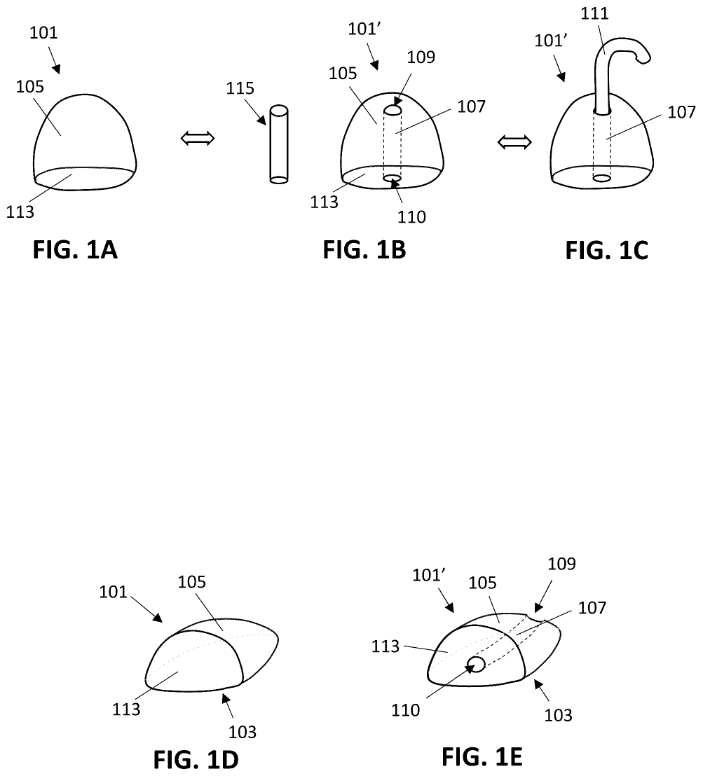

FIGS. 1A-1E illustrate one example of a convertible dental auxiliary device that has a first configuration adapted to act as an attachment for a patient-removable dental appliance, and a second configuration including an open channel that is configured to hold an orthodontic force accessory. In FIG. 1A, the convertible dental auxiliary device in the first configuration 101 is configured to be bonded to a tooth surface on one side (e.g., a tooth-bonding surface, shown in FIG. 1D), and includes a body region 105 that forms an engagement surface 131 for engaging a receiving region of a dental appliance when the dental appliance is worn on a patient's teeth over the convertible dental auxiliary device. The convertible dental auxiliary device in FIG. 1A is relatively low profile, and includes a smooth, uninterrupted outer surface. FIG. 1B shows the same convertible dental auxiliary device in the second configuration 101′ of FIG. 1A, in which a channel 107 extending through the body region 105 is accessible through a first channel opening 109 at one end and a second channel opening 110 at the opposite end (e.g., through the engagement surface 113). The channel 107 in this example is cylindrical and the device may be converted from the first configuration (FIG. 1A) to the second configuration (FIG. 1B) by removing the cylindrical material 115 from within the channel, as shown. FIG. 1C illustrates the convertible dental auxiliary device in the second configuration 101′ in which an orthodontic force accessory 111 is included and inserted into the channel 107 through the body region 105. In this example the orthodontic force accessory 111 is configured as a power arm structure having a hooked end region.

In other examples, the channel 107 may have a square or rectangular cross section. This may be particularly advantageous in cases where the convertible dental auxiliary device is configured to be used (in one of its configurations) with orthodontic wires to, e.g., allow for torsional bending of the wires and the application of a torque to the tooth to which the convertible dental auxiliary device is mounted. In some such cases, the orthodontic wire may have a square or rectangular cross section. In an example application, torque may be applied to alter an inclination of anterior teeth, torque may be applied about the axis of the wire to upright the molars and thus change the inclination, etc.

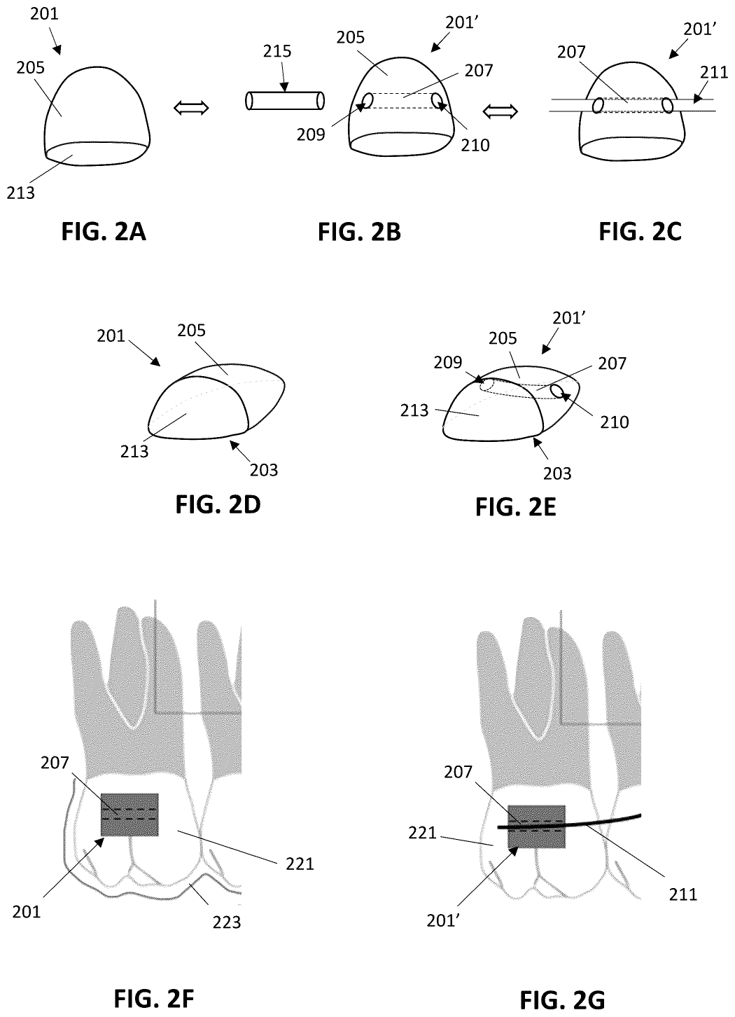

FIGS. 1D and 1E show side perspective views of the convertible dental auxiliary device in the first configuration (FIG. 1D) and the second configuration (FIG. 1E), respectively. In FIG. 1D the base of the convertible dental auxiliary device 101 is configured as a tooth-bonding surface 103 that may be shaped or formed to conform to the outer surface of a tooth and may be bonded thereto. FIG. 1E shows the convertible dental auxiliary device with the openings 109, 110 open into the channel 107 extending through the body. In FIGS. 1A-1E the channel is vertical, e.g., configured to extend perpendicular to the occlusal plane of the respective tooth to which the convertible auxiliary device is attached, and/or of the respective jaw, or within +/−15 degrees of a plane that is perpendicular to the occlusal plane, when attached to the tooth). As mentioned, this channel may be any appropriate orientation. For example, in FIGS. 2D-2G the channel extends horizontally, e.g., approximately along the occlusal plane or within +/−15 degrees of the occlusal plane of the respective tooth and/or the respective jaw when attached to the tooth.

In FIG. 2A a convertible dental auxiliary device in a first configuration 201 is shown in a first configuration that may be adapted for use with a patient-removable dental appliance (e.g., an aligner, a palatal expander for expanding a palate, an arch expander for expanding an upper or lower dental arch). The convertible dental auxiliary device includes a body region 205 that includes an engagement surface 213 that may transfer force from the patient-removable dental appliance to the tooth. FIG. 2B shows the conversion of the convertible dental auxiliary device from the first configuration to a second configuration in which a channel 207 (e.g., horizontal channel) extending through the body region 205 of the convertible dental auxiliary device in the second configuration 201′ is accessible through a first opening 209 and a second opening 210. The channel 207 and openings into the channel 209, 210 through the convertible dental auxiliary device may be exposed by removing a removable material 215 (e.g., plug, cylinder, etc.) from within the channel, as shown.

With the convertible dental auxiliary device in the second configuration an orthodontic force accessory, such as a wire 211 (e.g., an orthodontic wire for dental braces) may be inserted through the channel 207 in the body region 205 of the convertible dental auxiliary device 201′, as shown in FIG. 2C. Thus, the convertible dental auxiliary device may act as a bracket or guide. FIGS. 2D and 2E show side perspective views of the convertible dental auxiliary device 201, 201′ in the first configuration (e.g., FIG. 2A) and the second configuration (e.g., FIG. 2B and 2D). In this example, the base of the convertible dental auxiliary device is configured as a tooth-bonding surface 203 for attachment to a tooth.

FIGS. 2F-2G illustrate bonding of a convertible dental auxiliary device 201, 201′ to a tooth 221. FIG. 2F shows the convertible dental auxiliary device 201 in a first configuration with the convertible dental auxiliary device bonded to a buccal side of the tooth and forming an attachment that may be engaged by a receiving region of a dental appliance 223 when the dental appliance 223 is worn on a patient's teeth. In this example, the dental appliance 223 comprises a shell aligner having cavities for receiving the patient's teeth.

The same convertible dental auxiliary device shown in FIG. 2F may be converted to a second configuration in which a channel 207 through the dental appliance (which may be covered and/or occluded in the first configuration (FIG. 2F) is open and accessible, as shown in FIG. 2G. In this example, the convertible dental auxiliary device 201′ bonded to the tooth has been converted by removing one or more covers covering the channel 207 to allow access through the openings into the channel for a wire 211. In this example the convertible dental auxiliary device may be printed (e.g., 3D printed) and may include a channel, configured as a slot, for the wire 211. The wire may be secured in the channel.

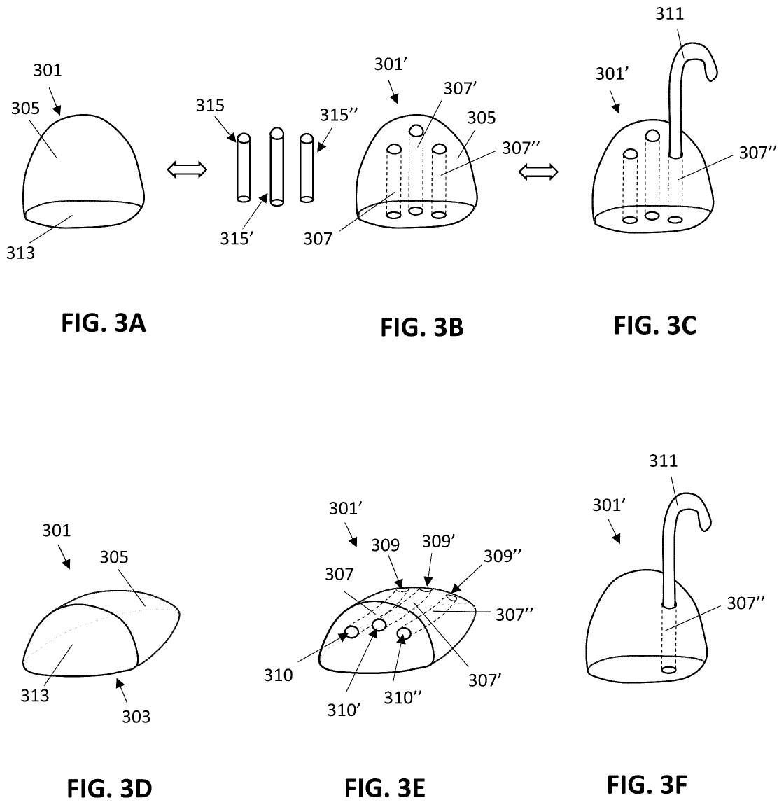

Any of the convertible dental auxiliary devices described herein may include multiple channels. For example, FIGS. 3A-3F illustrate a convertible dental auxiliary device having three separate channels 307, 307′, 307″ that may be used. FIG. 3A shows the convertible dental auxiliary device 301 in the first configuration, which is configured to engage a patient-removable dental appliance, so that an engagement surface 313 formed by the body region 305 of the device may transfer force between the dental appliance and the tooth onto which the convertible dental auxiliary device is bonded. This convertible dental auxiliary device includes three separate channels 307, 307′, 307″ as shown in FIG. 3B; each of these channels may be covered and/or filled with a removable material 315, 315′, 315″ that may be removed to expose the channel and channel openings 309, 310 when the device is in converted to the second configuration 301′. An orthodontic force accessory, such as an arm and/or hook 311, as shown in FIG. 3C may be inserted into one or more of the channels. In practice the other, unused, channels may remain covered, as shown in FIG. 3F. FIGS. 3D and 3E show side perspective views of the convertible dental auxiliary device in the first configuration, similar to FIG. 3A, and the second configuration, similar to that shown in FIG. 3B. The convertible dental auxiliary device also includes a tooth-bonding surface 303 that is configured to be bonded to the tooth surface. In FIG. 3E, each of the three channels 307, 307′, 307″ includes a channel opening at either end, e.g., a first channel opening 309, 309′, 309″ and a second channel opening 310, 310′, 310″. The second channel openings are positioned through the engagement surface 313 portion of the device 301′. Although the separate channels are illustrated as being parallel to each other, each of the separate channels may be in any orientation. For example, the channels may be oriented radially such that the axis of each channel is rotated radially from a central axis of the convertible dental auxiliary device. As another example, a first set of one or more channels may be oriented vertically and a second set of one or more channels may be oriented horizontally.

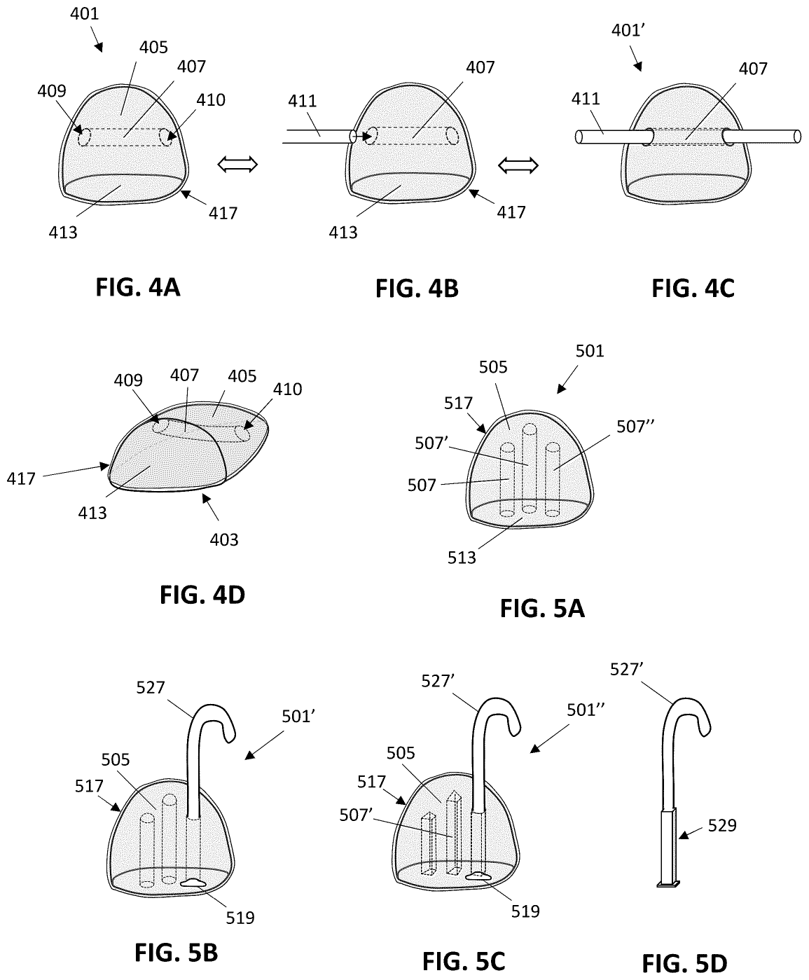

In some examples the convertible dental auxiliary device may include a cover over the body region that may cover the opening(s) into the channel and/or the channel itself. The cover may be removable/replaceable, such as a cap or the like. Alternatively, in some examples the cover may remain on the convertible dental auxiliary device, but may be penetrable so that, in the second configuration, the orthodontic force accessory may be inserted though the cover. This is illustrated in FIGS. 4A-4D and 5A-5B.

FIG. 4A shows an example of a convertible dental auxiliary device 401 including a cover 417 over the body region 405 of the convertible dental auxiliary device. The cover may be a coating or layer, e.g., of a polymeric material, such as a silicone or other relatively soft and biocompatible material. In some examples the cover may be over just a portion of the device (e.g., over or within the openings into the channel). In some examples the cover may be over the entire convertible dental auxiliary device. In some cases the cover may be over the body portion, but not on the tooth-bonding surface 403 of the convertible dental auxiliary device. In FIG. 4A the convertible dental auxiliary device is shown in the first configuration with a cover 417 covering the body region 405 of the device. A channel 407 through the body region is shown by the dashed lines. The convertible dental auxiliary device shown in FIG. 4A also includes an engagement surface 413 for engaging and transferring force from a patient-removable dental appliance. The first configuration of the convertible dental auxiliary device is configured to engage with a cavity or receiving region in the dental appliance. The convertible dental auxiliary device may be converted from the first configuration to the second configuration by inserting (penetrating or piercing) the cover 417 with an orthodontic force accessory; FIG. 4B illustrates the use of a wire 411 that may penetrate the cover and be inserted into the channel 407. In some examples the end of the orthodontic force accessory may be pointed, sharp or otherwise configured to penetrate the cover. The cover may be marked to indicate the location of the one or more openings into the channel. In some cases the outer surface of the convertible dental auxiliary device may be configured to indicate the opening region and channel beneath the cover. For example the outer surface may be shaped, textured, colored, or otherwise marked to indicate the location of the opening(s) 409, 410 into the channel. FIG. 4C shows an example of the convertible dental auxiliary device 401′ shown in FIGS. 4A-4B with a wire inserted through the cover and into the channel. The device may be converted back to the first configuration by removing the wire. FIG. 4D shows a side perspective view of the convertible dental auxiliary device of FIG. 4A, including the cover 417 over the body region 405, channel 407 through the body region, openings into the body region 409, 410 and an engagement surface 413.

FIGS. 5A-5B illustrate another example of a convertible dental auxiliary device 501, 501′ similar to that shown in FIGS. 3A-3F, but including an outer cover 517 over the body region 505. The device includes multiple different channels 507, 507′, 507″ that may be used. As in FIGS. 4A-4D these channels may be open, although covered by the penetrable cover 517. The cover covers the engagement surface 517 but, in this example, does not cover the tooth-bonding surface. In FIG. 5B the convertible dental auxiliary device is shown in the second configuration, with an orthodontic force accessory inserted through the channel by penetrating through the cover.

In FIG. 5B, as in any of the convertible dental auxiliary devices described herein, the orthodontic force accessory 527 may be secured within the channel, and may include or be configured to couple with, a retaining or locking base 519. The retaining/locking base may releasably secure the orthodontic force accessory within the channel. In some optional examples the orthodontic force accessory may include a catch, latch, or the like that may expand/compress to lock or unlock the orthodontic force accessory within the channel. In some examples the orthodontic force accessory may be formed of an elastically deformable material that may be displaced when inserting and may be displaced from a retaining configuration in order to release the orthodontic force accessory.

In any of these examples the orthodontic force accessory and/or channel may be configured to hold the orthodontic force accessory in a predetermined or adjustable orientation. For example the channel may have a non-circular cross-section (e.g., square, rectangular, triangular, etc.) cross-section that may engage with the body of the orthodontic force accessory so that the orthodontic force accessory does not rotate or substantially shift within the channel. For example, FIG. 5C shows an alternative configuration of a convertible dental auxiliary device 501″ in which the channels 507″ are shaped to retain the orthodontic force accessory 527′ in a fixed orientation, once inserted. An example of an orthodontic force accessory 527′ is shown in FIG. 5D; this accessory may be inserted into limited number of predefined orientations. For examples, an accessory such as the one shown, which has a rectangular cross-section, may be inserted in one of four different orientations. In some cases the orthodontic force accessory may be keyed to fit in to just a single orientation. The orthodontic force accessory may be formed of a metal or other material that is sufficiently durable to avoid fracture. In some cases the material may be an alloy, such as a nickel titanium alloy (NITINOL), or a stainless steel. The orthodontic force accessory may be a power arm or wire. Either or both the convertible dental auxiliary devices and the orthodontic force accessories for use with these devices may be prefabricated using the techniques described herein. In some cases the orthodontic force accessory may be fabricated of a material (e.g., metal, polymer, etc.) that is different from the material used to form the convertible dental auxiliary device, or they may be fabricated from the same material.

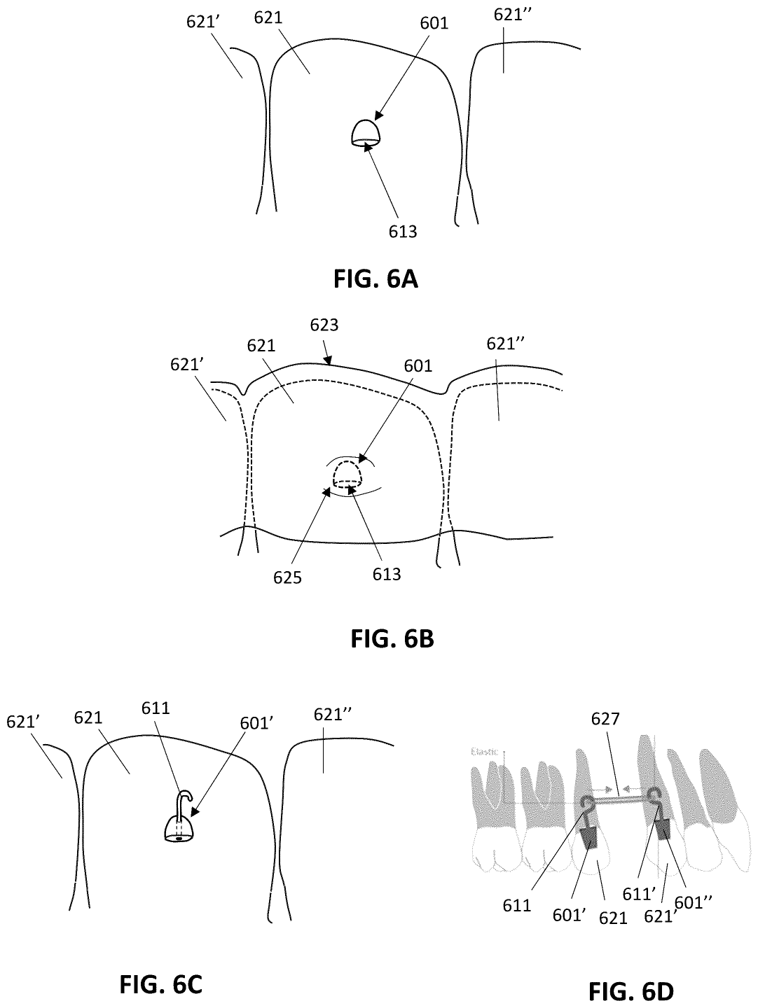

In use, the convertible dental auxiliary device may be bonded to a tooth, as described above, and shown in FIGS. 6A-6D. The convertible dental auxiliary device 601 may be bonded by any appropriate material, including light-curable dental cement, etc., to secure to the surface of a tooth. In FIG. 6A the convertible dental auxiliary device is shown bonded to a buccal surface of a tooth 621. More than one convertible dental auxiliary device may be used; including bonding to adjacent teeth 621′, 621″ and/or bonding multiple convertible dental auxiliary device to the same tooth. In some examples a mixture of convertible dental auxiliary devices and standard (e.g., non-converting) auxiliary devices may be used. In some cases multiple different types of convertible dental auxiliary devices may be used. FIG. 6A shows an example in which the convertible dental auxiliary device 601 is bonded in the first configuration so that an engagement region 613 is oriented as desired to engage with a receiving region 625 of a patient-removable dental appliance, as illustrated in FIG. 6B. In FIG. 6B a dental appliance, such as a shell aligner, 623 is applied over the patient's teeth 621, 621′, 621″ so that the teeth are received into tooth-receiving cavities of the dental appliance. The convertible dental auxiliary device 601 bonded to the tooth may engage with the convertible dental auxiliary device, and in particular, with the engagement surface 613 (or in some examples, surfaces) of the convertible dental auxiliary device, so that force may be applied by the dental appliance to the tooth or teeth. During some portions of the treatment of the patient's teeth the dental appliance 623 may be removed and the convertible dental auxiliary device may be converted for use with one or more orthodontic force accessories 611, as shown in FIG. 6C. in this example, the convertible dental auxiliary device is converted from the first configuration (for engaging with the dental appliance) to a second configuration for engaging with the orthodontic force accessory. As shown in FIG. 6B, the convertible dental auxiliary device has been converted to the second configuration by exposing a channel through the body of the convertible dental auxiliary device into which an orthodontic force accessor, shown as a power arm (e.g., arm and hook) 611 in this example. In practice the orthodontic force accessory 611 may be used to apply force to the tooth through the convertible dental auxiliary device 601, as illustrated in FIG. 6D. FIG. 6D illustrates an example showing a pair of convertible dental auxiliary devices 601′ 061″ both shown in the second configuration and both coupled to an orthodontic force accessory 611′, 611″. In this example an elastic band 627 is coupled between the orthodontic force accessories to apply a force to move the teeth 621, 621′.

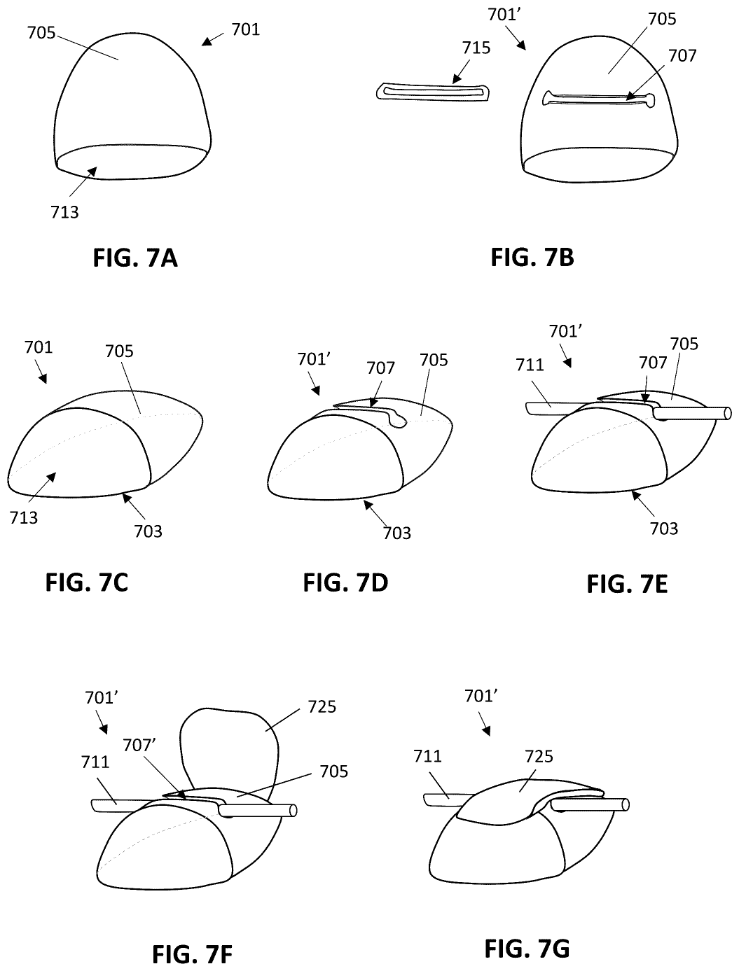

As mentioned, any of the convertible dental auxiliary devices described herein may include one or more channels, which may extend partially or completely through the body of the convertible dental auxiliary device. In some examples the channel may be configured as a slot that is partially open, as illustrated in FIGS. 7A-7E. FIG. 7A shows the convertible dental auxiliary device 701 in a first configuration adapted for use with a patient-removable dental appliance, as described above. The convertible dental auxiliary device in this first configuration includes a body region 705 having an outer surface profile that is relatively smooth, but includes one or more engagement surfaces 713. The convertible dental auxiliary device may be converted into a second configuration for securing an orthodontic force accessory by, in this example, removing a removable material 715 form the convertible dental auxiliary device, as shown in FIG. 7B. FIGS. 7C-7E illustrate side perspective views of the convertible dental auxiliary device shown in FIGS. 7A-7B. in FIG. 7C the convertible dental auxiliary device 701 is shown in the first configuration, similar to that shown in FIG. 7A. the base of the convertible dental auxiliary device is configured as a tooth-bonding surface 703. FIG. 7D shows the convertible dental auxiliary device 701′ in the second configuration having an exposed channel 707 formed as a slot extending horizontally across the body region 705. As shown in FIG. 7E an orthodontic force accessory 711, such as a wire, may be inserted through the channel, as shown. As discussed above, the channel (e.g., slots) may be arranged in any orientation.

In any of these convertible dental auxiliary devices, including (but not limited to) those shown in FIGS. 7A-7E, the convertible dental auxiliary device may be configured to lock. For example, the convertible dental auxiliary device may include a self-ligating lock to secure an orthodontic force accessory to/within the device. For example, any of these apparatuses may include a lock such as a clamp, snap, clasp, etc. FIGS. 7F-7G shows an example of a convertible dental auxiliary device 701′ similar to that shown in FIGS. 7A-7E with a lock, configured as a hinged self-ligating member. In FIG. 7F the lock is a hinged cover 725 that may open to expose the channel 707′ through the body 705 of the convertible dental auxiliary device into which a wire or other accessory 711 may be inserted. Once inserted, the orthodontic force accessory may be locked in place by closing the hinged cover (e.g., lid) 725, as shown in FIG. 7G. In some cases the hinged lid may include a clasp or other securement to hold the lid closed; this securement may be releasable to open the lid and remove the accessory. A lock, such as, but not limited to the lid or cover as shown in FIG. 7F-7G may be snap fit (or compression fit) to releasably hold in place. In some cases the lock may include a sliding element or latch to secure the accessory in place.

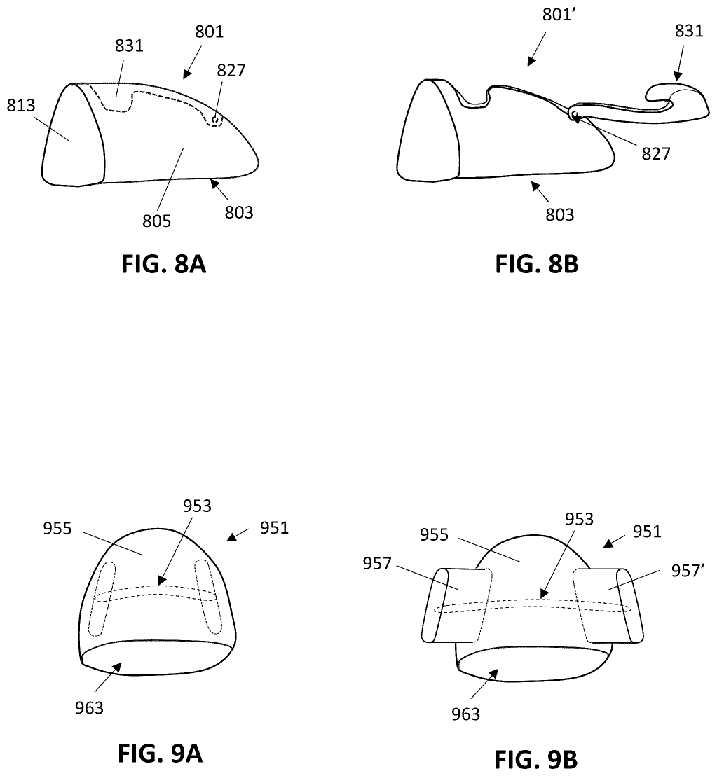

In some examples the convertible dental auxiliary device may be configured to include an integrated orthodontic force accessory that may be exposed by converting from the first configuration to a second configuration. FIGS. 8A-8B illustrates one example of a convertible dental auxiliary device that includes an extendable projection (e.g., arm and/or hook) that is configured to convert from a first configuration adapted for use with a patient-removable dental appliance to a second configuration in which the extendable projection is extended and may be used with a force-applying element such as an elastic band. In FIG. 8 the convertible dental auxiliary device 801 includes a tooth-bonding surface 803 and a body region 805 having an engagement surface 813. In the first configuration shown in FIG. 8A the convertible dental auxiliary device has a first, somewhat smooth outer profile. The convertible dental auxiliary device 801′ may be converted into a second configuration as shown in FIG. 8B, by extending a projection member 831 forming an arm and hook region. In this example the projection member may be extended by pivoting about a pivot or hinge 827. The projection member may be configured to be releasably held in the extended position and/or may be engaged with a force applying element, such as an elastic (not shown). The hinge or pivot may be a living hinge (e.g., it may be formed of a flexible material).

In some cases a convertible dental auxiliary device such as the one shown in FIGS. 8A-8B may also include a lock, as described above, which may secure the device in the open (FIG. 8B) and/or closed (FIG. 8A) configuration. The lock may be a self-ligating member, as described, a snap, tie, latch, etc.

In some examples the convertible dental auxiliary devices described herein may be configured so that they convert the one or more engagement surfaces between two or more configurations, with or without exposing a channel or integrated orthodontic force accessory. For example, the convertible dental auxiliary devices described herein may convert the one or more engagement surfaces into engagement surfaces of different sizes, shapes and/or orientations.

For example, the convertible dental auxiliary devices described herein may change size. For example, the convertible dental auxiliary devices may expand and/or contract to increase the size of a contact area with an auxiliary device, which may change the contact angle and/or vector of force (magnitude and/or direction) applied to the tooth/teeth. FIGS. 9A-9B illustrate one example of an apparatus that is configured to expand open, and may include one or more wings 957, 957′ that may be extended or retracted. For example, in FIG. 9A the convertible dental auxiliary device 951 includes a body region 955 having an engagement surface 963. In FIG. 9A the convertible dental auxiliary device is shown in a contracted configuration, in which the body is relatively narrow. The device may include a channel or other engagement region or surface 953. As in any of these examples, the convertible dental auxiliary device may include a bonding surface configured to be bonded to a tooth surface. The convertible dental auxiliary device shown in FIGS. 9A-9B also include a pair of extensions (e.g., extension wings) 957, 957′ shown fully extended in FIG. 9B. In FIG. 9B both extensions are fully extended. In some cases only one extension may be extended, and/or one or both extensions may be extended to a lesser degree. The extensions may include an internal support structure (not shown) providing support to the extensions. In FIG. 9B when the extensions are extended fully or partially, they may be locked in place to prevent them from closing or expanding open further. For example, the convertible dental auxiliary device may include a pin, latch, screw, or other mechanism to secure the position of the extension(s). Each extension may be separately secured or the two may be secured together. In FIG. 9B the extensions on the convertible dental auxiliary device are configured to extend the engagement region.

In some examples the orientation or contact angle of the engagement surface(s) may be changed. Changing the orientation and/or contact angle may alter the direction and/or force magnitude applied by the patient-removable dental appliance.

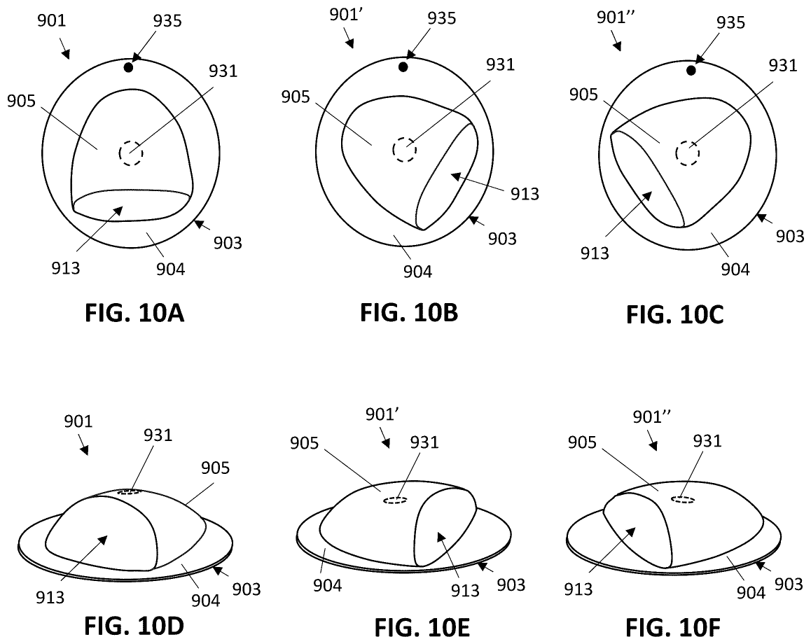

FIGS. 10A-10F illustrate one example of a convertible dental auxiliary device that is configured to adjust the orientation of the engagement region. FIG. 10A shows an example of a convertible dental auxiliary device 901 that is configured to convert to adjust the orientation of the engagement surface 913. The convertible dental auxiliary device in this example includes a tooth-bonding surface 903 forming a base 904 that is rigidly coupled (e.g., bonded) to the tooth surface. The convertible dental auxiliary device also includes a body region 905 that extends from the tooth-bonding surface and base. The body region 905 forms a protrusion having a first contact profile in this first configuration, including an engagement surface 913. The contact profile contacts the receiving region of the patient-removable dental appliance when the dental appliance is worn, and has an orientation, shape and size, including contact angle, e.g., of the engagement region, which may be matched with the patient-removable dental appliance. In this example the protrusion formed by the body region 905 may be moved relative to the base, e.g., by rotating about a pivot 931 in order to change the orientation of the contact profile, and in particular the orientation of the engagement region 913, as shown in FIGS. 10B and 10C. In FIG. 10B the protrusion of the body region 905 of the convertible dental auxiliary device 901′, including the engagement surface 913 is rotated by pivoting around pivot 931 relative to the base. In FIGS. 10A-10C an optional fiducial mark 935 is included for reference. In FIG. 10C, the convertible dental auxiliary device 901″ may include one or more additional orientations. The amount of the rotation between the two or more different orientations may be predetermined, e.g., the convertible dental auxiliary device may have a set angle or position to which it may be converted, or it may be continuously pivoted. In FIGS. 10B and 10C, the additional configurations may therefore have a different contact profile from the first contact profile (FIG. 10A). The body region 905 is convertible between the first configuration and the additional configurations by moving the one or more protrusions relative to the tooth bonding surface, as shown.

FIGS. 10D, 10E and 10F show side perspective views, respectively, of the different configurations of the convertible dental auxiliary device shown in FIGS. 10A, 10B and 10C, respectively.

As described above, any of these convertible dental auxiliary apparatuses may be configured to lock into place. For example, the convertible dental auxiliary devices shown in FIGS. 10A-10F may include a self-locking mechanism such as a compression spring that may hold the position and/or configuration of the convertible dental auxiliary device. In some cases the compression spring may create friction that may hold the position of the convertible dental auxiliary device. In some cases the convertible dental auxiliary devices described herein may include a locking pin or fastener that may fit into a slot to releasably hold the locking pin/fastener in place until it is release (e.g., by pushing against the spring). For example, the convertible dental auxiliary device or a portion of the convertible dental auxiliary device (e.g., a lock) may be pushed in to disengage a pin, then moved (e.g., rotated) to a new position/configuration, after which the pin may be allowed to engage with the same or a different slot or other location.

The example convertible dental auxiliary devices shown in FIGS. 10A-10F may also include any of the features described above, including slots/channels, etc. that may engage one or more accessory (e.g., wires, etc.). Any of these apparatuses may be configured to be pushed or pulled (e.g., to release, move/rotate, and re-engage) to secure the device in the various configurations. For example, in FIGS. 10A-10F the pivot 931 may include or be coupled to bias, such as a spring (e.g., leaf spring) to allow it to be pulled or pushed and/or rotated and released. The apparatus may include post or beam (e.g., forming the pivot 931) that may couple to a spring that may engage/disengage the pivot, requiring the use to apply force (e.g., to push in) to rotate the convertible dental auxiliary device.

Alternatively or additionally, any of these apparatuses may include an undercut region that may be configured to allow a portion of the convertible dental auxiliary device to be pulled up (e.g., to disengage a lock or locking pin preventing movement) and once disengaged, may be moved, e.g., rotated, as shown in FIGS. 10A-10F) before being pushed back down and re-locked once in position.

In general, these apparatuses may be configured so that the active surface (e.g., the engagement surface 913) may be adjusted to control the orientation of the active surface relative to the teeth. This may therefore allow a single attachment to provide multiple different and selectable resultant force vectors when treating a patient at different stages. This may further permit much more precise tooth movement and control of tooth movement during a treatment.

For example, during a treatment, a treatment plan may be divided into multiple stages during which specific tooth movements may be made. The convertible dental auxiliary devices described herein may change their size and/or orientations for different treatment stages, for use with the same dental appliance (e.g., aligner, palatal expander, etc.) or with different dental appliances. For example, the convertible dental auxiliary device may re-orient the active surface (the engagement surface) between stages. For example, the convertible dental auxiliary device having an orientation as shown in FIG. 10A can be used at a first stage or stages (e.g., stages 1-9), while the orientation of the convertible dental auxiliary device shown in FIG. 10B can be used at a later stage (e.g., stage 10). Thus, the same attachment may be re-used instead of having to remove, form a new attachment, and bond the new attachment to the teeth.

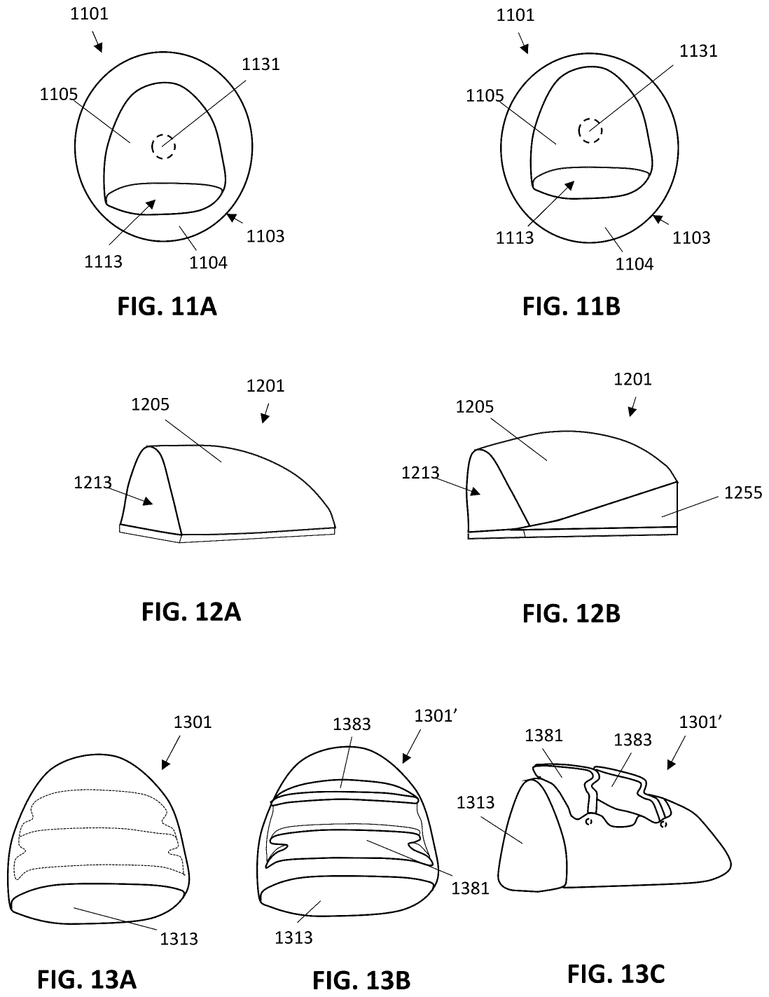

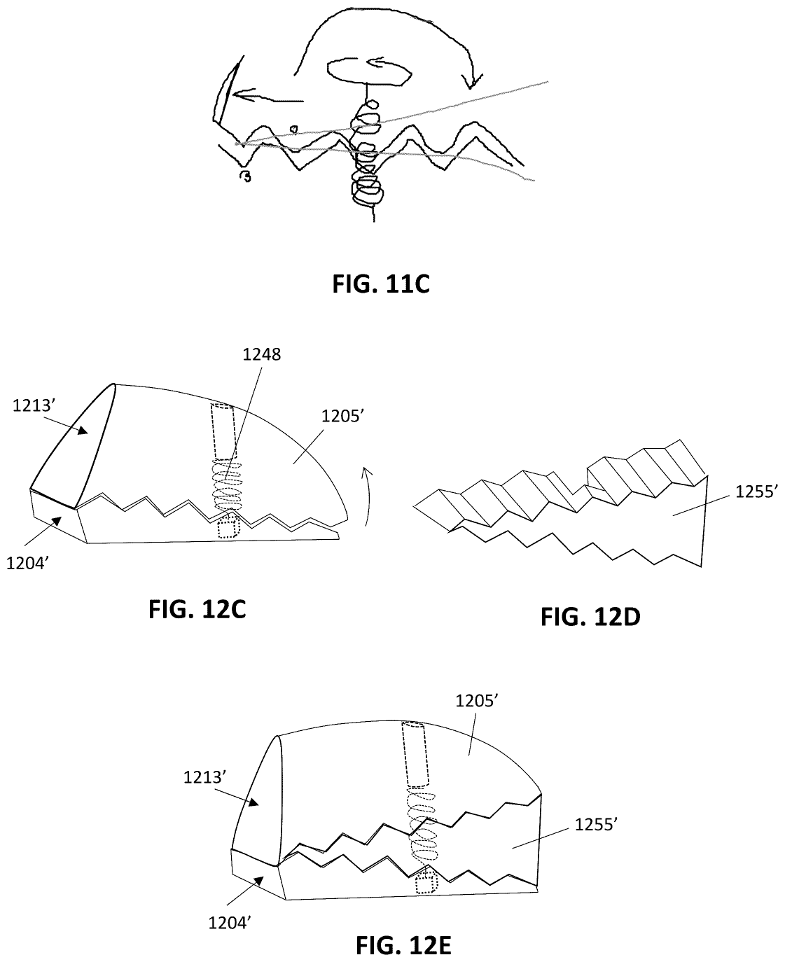

In addition to rotational movement, the convertible dental auxiliary devices described herein may also provide linear motion, including by sliding side-to side or up/down and/or expanding/contracting (as shown in FIGS. 9A-9B). For example, FIGS. 11A-11B show an example of a convertible dental auxiliary device 1101 that is configured to move linearly after the base 1104 is bonded to a tooth surface by a tooth bonding surface 1103. The user (e.g., dental professional) may release a releasing pin 1131. The pin may be held in place, e.g., by a bias (spring) that may be released by pushing (or in some cases pulling) either manually or using a tool (e.g. probe) so that the body 1105, allowing the body to be slid, e.g., in a slot or track, in a predetermined direction, such as a linear (up/down, left/right, along a curve, etc.) direction before being locked into position again. This may therefore change the relative position of the engagement surface 1113 on the base 1104.

In some cases the body of the convertible dental auxiliary device may be removable from the base (e.g., the base 1104) and replaced with a different body portion that may provide a different orientation of the engagement surface, a different shape/size, or a different position. For example, a patient with erupting teeth may start with a first body having a first shape and/or size fixed to a base that is fixed to the patient's tooth. As the tooth erupts and there is more room and/or as the angle of the tooth surface change, the first body may be replaced with a second body having a different shape and/or size (e.g., a larger attachment, an attachment with an active surface that is angled differently).

Also described herein are convertible dental auxiliary devices that may change the pitch and/or yaw (e.g., the tilt) of the engagement surface. For example, FIGS. 12A-12B illustrate an example of a convertible dental auxiliary device that may change the angle of the device relative to the tooth after it has been bonded to the tooth surface. The convertible dental auxiliary device 1201 includes a body region 1205 and an engagement surface 1213 that may engage with a dental appliance. Alternatively or additionally the device may include a channel or other region for engaging with an auxiliary such as a wire, elastic, power arm, etc. The relative angle of the convertible dental auxiliary device 1201 (e.g., the engagement surface 1213) may be changed. In some cases the body region may be coupled to a pivot, and may be retained by a pin or other retainer that may be biased in a locked configuration but may be controllably released to allow the body of the convertible dental auxiliary device 1201 to pivot, changing the tilt angle of the device relative to the tooth, as shown in FIG. 12B. In some cases convertible dental auxiliary device 1201 may be configured to be shimmed, e.g., by adding or removing a shim. The convertible dental auxiliary device 1201 may be coupled to bias pulling it down towards a base that may be bonded to the tooth surface; the bias may allow the convertible dental auxiliary device 1201 to be pulled up, away from the base, so that a wedge-shaped shim may be inserted and/or removed to change relative angle of the convertible dental auxiliary device 1201; releasing the body region may allow the bias to again clamp down onto the base, including onto any shim.

In some configurations, the base and body region may include a sawtooth interface that may allow adjustment of the height of at least a portion of the body relative to the base on one or more sides, e.g., changing tilt, changing overall height. For example, FIGS. 12C-12E illustrate examples of a saw-tooth interface configure to secure a shim (FIG. 12D) that may change the angle of the engagement surface 1213′ by inserting/removing the shim 1255′, which includes complimentary surfaces for engaging the sawtooth interface. In this example, the base 1204′ and body 1205′ may be connected by a bias (e.g., spring 1248) that may lock the body to the base both without (FIG. 12C) and with (FIG. 12E) the shim between the two. Additionally or alternatively, a similar sawtooth interface may be used to adjust a horizontal position of the body relative to the base, as shown in FIG. 11C. For example, the body may have a surface with peaks and valleys configured to mate with opposing peaks and valleys of the base, and thereby interface and lock in the body with the base. In this example, the base may be moved relative to the body to a new position (e.g., raised by activating a spring or other mechanism and then moved to a new position) where different peaks and valleys interface (e.g., and may then be dropped into place to lock the body with the base in the new position). One or more additional extension (e.g., pegs) may prevent lateral movement or the sawtooth pattern may form a chevron pattern in the other dimension.

FIGS. 13A-13C illustrate one example of a convertible dental auxiliary device 1301, 1301′ having extendible projections that may convert form the dental auxiliary (e.g., dental attachment) from a first configuration having a relatively smooth outer surface, shown in FIG. 13A, to a second configuration forming a channel therethrough for engaging with a wire and/or elastic, as shown in FIGS. 13B and 13C. In FIG. 13A the convertible dental auxiliary device 1301 is configured to engage a patient-removable dental appliance. The device includes an engagement surface 1313. FIG. 13B shows the same device in the second, e.g., bracket configuration, for use with a dental wire. The first configuration may be converted to the second configuration by rotating a pair of wings 1383, 1381 away from the body to expose a channel (as discussed above) in which a wire may extend. The wings may also form attachment sites for one or more elastics, e.g., to secure the wire in the channel of the dental auxiliary device. FIG. 13B shows a top perspective view and FIG. 13C shows a side perspective view, respectively. In FIGS. 13B and 13C the convertible dental auxiliary device 1301′ is shown in the bracket configuration, in which a set of projections extend outward from the convertible dental auxiliary device. These projections can then engage orthodontic wires and/or elastics. Such a device can be used in a multi-phase treatment that may, for example, involve using dental braces first, followed by an aligner (or vice versa).

As mentioned above, any of these apparatuses may include be configured for use with one or more appliances used to treat a patient's dentition. For example, these apparatuses may be used for both palatal expansion, in which a palatal expander may be used, and orthodontic alignment, e.g., in which a dental aligner may be used. These apparatuses may be used for both patient-removable appliances and non-removable (e.g., orthodontic wires) during different phases of treatment without requiring removal of these convertible dental auxiliary devices. For example, the same convertible dental auxiliary device may be used for multiple phases of treatment, including during a palatal expansion phase and during an alignment phase. During the palatal expansion phase the convertible dental auxiliary devices may be used with one or more palatal expanders, including assisting in retaining a palatal expander during the expansion of the palate. During the alignment phase the convertible dental auxiliary devices may engage with one or more aligners and/or orthodontic wires. The convertible dental auxiliary devices described herein may be used for upper arch (palatal) expansion and/or for lower arch expansion. These convertible dental auxiliary devices may also be used for one or more lingual auxiliary treatments in which the convertible dental auxiliary devices may be positioned on a lingual tooth surface and converted between aligner engagement configurations and/or bracket configurations. Lingual attachment may be used for any of the treatments described herein (e.g., expansion of the upper and/or lower jaws, aligning of teeth and/or retaining tooth position).

Any of the convertible dental auxiliary devices described herein may be used to treat a patient's dentition. One or more convertible dental auxiliary devices may be attached to the patient's teeth at the start of (or in the midst of) a dental/orthodontic treatment. The convertible dental auxiliary device may be bonded in a predetermined positions, on predetermined tooth locations. The same convertible dental auxiliary devices may be used both for coupling to (securing and/or assisting in applying forces from) one or more patient-removable appliances and may also be used during the same treatment, for applying force from one or more orthodontic force accessories. In some cases, the convertible dental auxiliary device may function similar to brackets in wire-and-bracket orthodontic treatments and/or power arms. The convertible dental auxiliary devices may therefore be positioned on the teeth to function both in applying force from one or more patient-removable dental appliance as well as applying force using one or more orthodontic force accessories, such as wires and/or arms.

These convertible dental auxiliary devices may allow for the sequential application of force through the convertible dental auxiliary device from patient-removable dental appliances and from orthodontic force accessories, e.g., separately apply/wear aligners and wires/arms, or concurrent application of force from patient-removable dental appliances and from orthodontic force accessories, e.g., using aligners at the same time as using wires/arms.

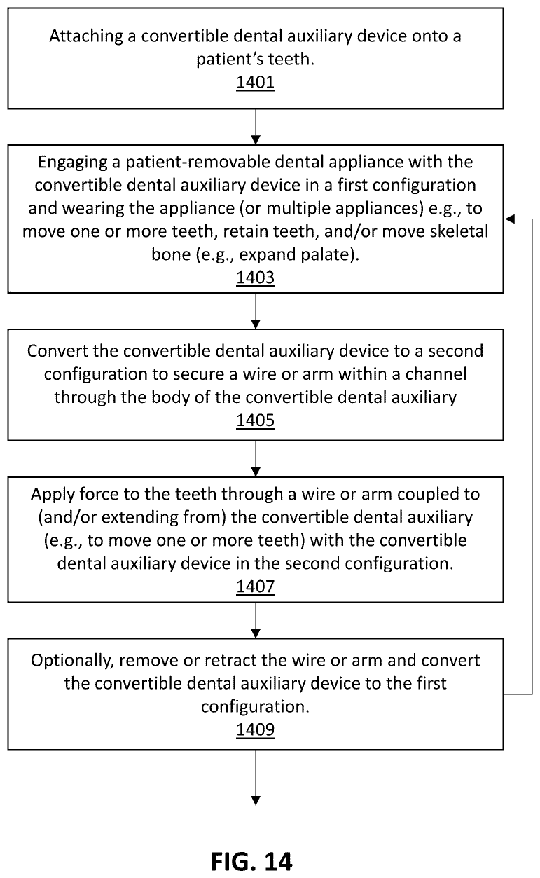

FIG. 14 illustrates one example of a method of using convertible dental auxiliary devices to move teeth. For example, in FIG. 14, the method may include optionally bonding (e.g., attaching) one or more (preferably two or more) convertible dental auxiliary devices onto a patient's teeth 1401. These devices may be positioned according to a predetermined treatment plan, in order to optimize the applied forces in both the first configuration (when coupled to a patient-removable dental appliance) and a second configuration (e.g., when coupled to or forming an orthodontic force accessory).

The method may generally include converting either or both between the first configuration and the second configuration. In some cases the method may include converting between multiple configurations. These methods may include converting a convertible dental auxiliary device that is bonded to patent's tooth from a first configuration to a second configuration or from a second configuration to a first configuration, wherein the first configuration comprises an engagement surface for engaging a receiving region of a dental appliance when the dental appliance is worn on the patient's teeth and wherein the convertible dental auxiliary device comprises one or more channels extending at least partially through a body of the convertible dental auxiliary device and a channel opening. The one or more openings may be open in the second configuration and closed in the first configuration.

For example, in FIG. 14, the method may include engaging a patient-removable dental appliance with the convertible dental auxiliary device in a first configuration and wearing the appliance (or multiple appliances) e.g., to move one or more teeth, retain teeth, and/or move skeletal bone (e.g., expand palate) 1403.

Following the application of force from one or more patient-removable dental appliances worn over the device in the first configuration, the device may be converted to the second configuration for engaging one or more orthodontic force accessories. For example, the method may include converting the convertible dental auxiliary device to the second configuration to secure a wire or arm within a channel through the body of the convertible dental auxiliary 1405. Force may then be applied from the orthodontic force accessories. For example, the method may include applying force to the teeth through a wire or arm coupled to (and/or extending from) the convertible dental auxiliary (e.g., to move one or more teeth) with the convertible dental auxiliary device in the second configuration 1407. Thereafter the method may optionally include removing or retracting the orthodontic force accessory (e.g., wire or arm) and convert the convertible dental auxiliary device to the first configuration 1409.

Alternatively in some cases the method may first use the convertible dental auxiliary device in the second configuration (1407) and then convert to the first configuration (1403).

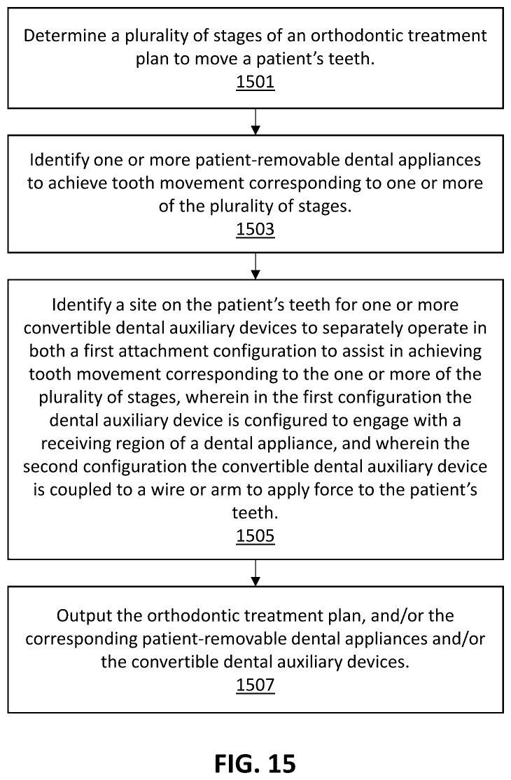

In some examples these methods may comprise or include forming the dental treatment plan that accommodates and/or takes advantage of the use of one or more convertible dental auxiliary devices. FIG. 15 illustrates one example of such as method, which may be performed as part of a method of using these device of may be performed separately. The method shown in FIG. 15 may be performed as part of a software or firmware, e.g., may be part of a non-transitory computer-readable storage medium storing a set of instructions for performing these steps.

In FIG. 15, the method may generally include determining a plurality of stages of an orthodontic treatment plan to move a patient's teeth 1501. This may include identifying one or more patient-removable dental appliances to achieve tooth movement corresponding to one or more of the plurality of stages 1503. Alternatively or additionally, this may include designing one or more patient-removable dental appliances.

The method may also include identifying a site on the patient's teeth for one or more convertible dental auxiliary devices to separately operate in both a first attachment configuration to assist in achieving tooth movement corresponding to the one or more of the plurality of stages, wherein in the first configuration the dental auxiliary device is configured to engage with a receiving region of a dental appliance, and wherein the second configuration the convertible dental auxiliary device is coupled to a wire or arm to apply force to the patient's teeth 1505. In some examples the step of identifying the one or more dental appliances may include or account for the use of the one or more convertible dental auxiliary devices. Any of these methods may also include selecting the convertible dental auxiliary devices from a library of device, and/or designing or modifying the design of one or more convertible dental auxiliary devices.

The treatment plan may be iteratively formed, as the convertible dental auxiliary devices are selected, and the dental appliances are configured.

The ability to include and account for the application of force through the dental auxiliary as part of the treatment plan may permit fewer stages to be used, and/or more efficient movements of the teeth.

Once the treatment plan in designed, it may be presented to a user and/or adjusted before being finalized. Once finalized, the treatment plan may be output. Outputting the treatment plan may include outputting the corresponding patient-removable dental appliances and/or the convertible dental auxiliary devices 1507. Outputting may include fabricating the convertible dental auxiliary device(s) and/or dental appliances.

The convertible dental auxiliary devices described herein may be fabricated using any appropriate method. For example, the convertible dental auxiliary device may be fabricated from a digital model that may be used to directly fabricate the convertible dental auxiliary device using a direct fabrication technique including any of those described herein. Thus, fabricating of the convertible dental auxiliary devices may include preparing a digital file with the design of the convertible dental auxiliary device that may be used for automatic fabrication, e.g., by a three-dimensional (3D) fabrication technique, such as, but not limited to, 3D printing. e.g., vat photopolymerization, material jetting, light polymerization (e.g., stereolithography/SLA, digital light processing (DLP), continuous liquid interface production (CLIP), etc.), binder jetting, powder bed fusion (e.g., laser metal deposition (LMD), electron beam melting (EBM), selective laser melting (SLM), selective heat sintering (SHS), direct metal laser sintering (DMLS), etc.), material extrusion (e.g., direct ink writing (DIW), extrusion based additive manufacturing, etc.), and/or directed energy deposition. For example, fabricating may include exporting a digital file comprising the model of the convertible dental auxiliary device and/or a placement device (e.g., jig, frame, guide, etc.) to position the convertible dental auxiliary device, and to which the convertible dental auxiliary device may be connected. In some examples, fabrication may mean preparing and/or outputting the digital file with the design of the convertible dental auxiliary device. In some examples, fabrication may include forming the convertible dental auxiliary device. The convertible dental auxiliary device may be fabricated by 3D printing.

All publications and patent applications mentioned in this specification are herein incorporated by reference in their entirety to the same extent as if each individual publication or patent application was specifically and individually indicated to be incorporated by reference. Furthermore, it should be appreciated that all combinations of the foregoing concepts and additional concepts discussed in greater detail below (provided such concepts are not mutually inconsistent) are contemplated as being part of the inventive subject matter disclosed herein and may be used to achieve the benefits described herein.

Any of the methods (including user interfaces) described herein may be implemented as software, hardware or firmware, and may be described as a non-transitory computer-readable storage medium storing a set of instructions capable of being executed by a processor (e.g., computer, tablet, smartphone, etc.), that when executed by the processor causes the processor to control perform any of the steps, including but not limited to: displaying, communicating with the user, analyzing, modifying parameters (including timing, frequency, intensity, etc.), determining, alerting, or the like. For example, any of the methods described herein may be performed, at least in part, by an apparatus including one or more processors having a memory storing a non-transitory computer-readable storage medium storing a set of instructions for the processes(s) of the method.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the example embodiments disclosed herein.

As described herein, the computing devices and systems described and/or illustrated herein broadly represent any type or form of computing device or system capable of executing computer-readable instructions, such as those contained within the modules described herein. In their most basic configuration, these computing device(s) may each comprise at least one memory device and at least one physical processor.

The term “memory” or “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices comprise, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “processor” or “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors comprise, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the method steps described and/or illustrated herein may represent portions of a single application. In addition, in some embodiments one or more of these steps may represent or correspond to one or more software applications or programs that, when executed by a computing device, may cause the computing device to perform one or more tasks, such as the method step.

In addition, one or more of the devices described herein may transform data, physical devices, and/or representations of physical devices from one form to another. Additionally or alternatively, one or more of the modules recited herein may transform a processor, volatile memory, non-volatile memory, and/or any other portion of a physical computing device from one form of computing device to another form of computing device by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media comprise, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

The processor as described herein can be configured to perform one or more steps of any method disclosed herein. Alternatively or in combination, the processor can be configured to combine one or more steps of one or more methods as disclosed herein.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under”, or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

In general, any of the apparatuses and methods described herein should be understood to be inclusive, but all or a sub-set of the components and/or steps may alternatively be exclusive and may be expressed as “consisting of” or alternatively “consisting essentially of” the various components, steps, sub-components or sub-steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The present disclosure includes the following numbered clauses.
Clause 1, a convertible dental auxiliary device, the device comprising: a tooth-bonding surface configured to be bonded to a tooth surface; and a body region extending from the tooth-bonding surface, wherein the body region comprises a channel extending at least partially through the body region and a channel opening configured to receive an orthodontic force accessory within the channel, wherein the body region is convertible between a first configuration and a second configuration, wherein the channel opening is closed in the first configuration, and wherein the channel opening is open in the second configuration.
Clause 2, the device of clause 1, wherein, in the first configuration, the body region forms an engagement surface for engaging a receiving region of a dental appliance when the dental appliance is worn on a patient's teeth, wherein the dental appliance comprises a shell having one or more cavities for receiving one or more teeth of the patient.
Clause 3, the device of clause 1, wherein, in the first configuration a removable material is held within the channel.
Clause 4, the device of clause 1, further comprising a cover configured to cover the channel opening in the first configuration.
Clause 5, the device of clause 4, wherein the cover is removable from the channel opening.
Clause 6, the device of clause 4, wherein the cover is hinged to the device.
Clause 7, the device of clause 4, wherein the cover comprises a penetrable material configured to be pierced to provide access to the channel.
Clause 8, the device of clause 1, wherein, in the second configuration, the orthodontic force accessories comprise a power arm that is configured to be secured within the channel.
Clause 9, the device of clause 1, wherein the channel comprises a vertical slot.
Clause 10, the device of clause 1, wherein the channel comprises a horizontal slot.
Clause 11, the device of clause 1, wherein the channel is one of a plurality of channels.
Clause 12, a method of treating a patient's teeth, the method comprising: converting a convertible dental auxiliary device that is bonded to patent's tooth from a first configuration to a second configuration or from a second configuration to a first configuration, wherein the first configuration comprises an engagement surface for engaging a receiving region of a dental appliance when the dental appliance is worn on the patient's teeth, wherein the dental appliance comprises a shell having one or more cavities for receiving one or more teeth of the patient, further wherein the convertible dental auxiliary device comprises one or more channels extending at least partially through a body of the convertible dental auxiliary device, and wherein, in the second configuration one or more openings provide access into the one or more channels; and securing an orthodontic force accessory within a channel of the one or more channels in the second configuration.
Clause 13, the method of clause 12, further comprising applying force to the patient's teeth from the orthodontic force accessory secured to the channel of the convertible dental auxiliary device in the second configuration to move one or more teeth and applying force to the patient's teeth from the dental appliance engaged with the convertible dental auxiliary device in the first configuration to move one or more teeth.
Clause 14, the method of clause 12, further comprising bonding a tooth-bonding surface of the convertible dental auxiliary device to the patient's teeth.
Clause 15, the method of clause 12, wherein converting comprises removing a material from at least one of the one or more channels to convert the convertible dental auxiliary device from the first configuration to the second configuration.
Clause 16, the method of clause 12, wherein converting comprises removing a cover from the channel to convert the convertible dental auxiliary device from the first configuration to the second configuration.
Clause 17, the method of clause 12, wherein converting comprises piercing a penetrable material covering the channel to convert the convertible dental auxiliary device from the first configuration to the second configuration.
Clause 18, the method of clause 12, further comprising converting the convertible dental auxiliary device from the second configuration to the first configuration.
Clause 19, the method of clause 12, wherein securing the orthodontic force accessory within the channel comprises inserting a wire or arm through the one or more openings into the channel.
Clause 20, a method for generating an orthodontic treatment plan for a patient, the method comprising: determining a plurality of stages of the orthodontic treatment plan to move the patient's teeth from an initial configuration to a final configuration; identifying, as part of the orthodontic treatment plan, one or more patient-removable dental appliances to be worn over the patient's teeth during one or more stages of the plurality of stages; identifying, as part of the orthodontic treatment plan, a bonding site on the patient's teeth for one or more convertible dental auxiliary devices to separately operate in both a first configuration and a second configuration, wherein in the second configuration the one or more convertible dental auxiliary devices are coupled to an orthodontic force accessory to apply force to the patient's teeth and wherein in the first configuration the one or more convertible dental auxiliary devices are not coupled to the orthodontic force accessory and are engaged with a receiving region of a patient-removable dental appliance; and outputting the orthodontic treatment plan.
Clause 21, the method of clause 20, wherein outputting the orthodontic treatment plan comprises fabricating at least one of the one or more patient-removable dental appliances.
Clause 22, the method of clause 20, wherein outputting the orthodontic treatment plan comprises fabricating at least one of the one or more convertible dental auxiliary devices and/or a template for holding the one or more convertible dental auxiliary devices in the identified bonding site.
Clause 23, the method of clause 20, wherein identifying the bonding site on the patient's teeth comprises estimating a force applied by the one or more convertible dental auxiliary devices in the second configuration, and estimating the force applied by the one or more patient-removable dental appliances and the one or more convertible dental auxiliary devices in the first configuration.
Clause 24, the method of clause 20, further comprising identifying the one or more convertible dental auxiliary devices.
Clause 25, the method of clause 24, wherein identifying the convertible dental auxiliary devices comprises designing the one or more convertible dental auxiliary devices.
Clause 26, the method of clause 20, further comprising identifying which stage of the orthodontic treatment plan to convert the one or more convertible dental auxiliary devices from the second configuration to the first configuration and/or from the first configuration to the second configuration.
Clause 27, a system, the system comprising: a convertible dental auxiliary device comprising: a tooth-bonding surface configured to be bonded to a tooth surface; and a body region extending from the tooth-bonding surface, wherein the body region comprises a channel extending at least partially through the body region and a channel opening configured to receive an orthodontic force accessory within the channel, wherein the body region is convertible between a first configuration and a second configuration, wherein the channel opening is closed in the first configuration, and wherein the channel opening is open in the second configuration; one or more dental appliances each comprising a receiving region that is configured to engage with an engagement surface of the body region when the body region is in the first configuration; and an orthodontic force accessory that is configured to be received by the channel of the convertible dental auxiliary device in the second configuration.
Clause 28, the system of clause 27, wherein the one or more dental appliance comprises: an aligner, a palatal expander, a lower arch expander, or a retainer.
Clause 29, the system of clause 27, further comprising one or more second dental appliances configured to be worn on the subject's teeth when the convertible dental appliance is in the second configuration.
Clause 30, the system of clause 27, wherein, in the first configuration, a removable material is held within the channel.
Clause 31, the system of clause 27, further comprising a cover configured to cover the channel opening in the second configuration.
Clause 32, the system of clause 27, wherein the cover is removable from the channel opening.
Clause 33, the system of clause 27, wherein the cover is hinged to the device.
Clause 34, the system of clause 27, wherein the cover comprises a penetrable material configured to be pierced to provide access to the channel.
Clause 35, the system of clause 27, wherein the channel comprises a vertical slot.
Clause 36, the system of any one of clauses 27-35, wherein the channel comprises a horizontal slot.
Clause 37, the system of clause 27, wherein the channel is one of a plurality of channels.
Clause 38, a convertible dental auxiliary device, the device comprising: a tooth-bonding surface configured to be bonded to a tooth surface; and a body region extending from the tooth-bonding surface, wherein the body region comprises one or more protrusions forming a first contact profile in a first configuration, and a second configuration comprising a second contact profile that is different from the first contact profile, wherein the first contact profile is configured to engage with a receiving region of one or more patient-removable dental appliances when the one or more dental appliances is worn on a patient's teeth, further wherein the body region is convertible between the first configuration and the second configuration by moving the one or more protrusions relative to the tooth bonding surface.
Clause 39, the device of clause 38, wherein the second contact profile comprises an arm and/or hook.
Clause 40, the device of clause 38, wherein the second contact profile comprises a wing.
Clause 41, the device of clause 38, wherein the first contact profile comprises a first engagement surface configured to engage a receiving region of a dental appliance when the dental appliance is worn on a patient's teeth.
Clause 42, the device of clause 38, wherein the first contact profile is configured to engage a receiving region of a first dental appliance when the first dental appliance is worn on a patient's teeth and wherein the second contact profile is configured to engage a receiving region of a second dental appliance when the second dental appliance is worn on the patient's teeth.
Clause 43, the device of clause 42, wherein the first contact profile comprises a first engagement surface having a first contact angle in the first configuration and wherein the second contact profile comprises a second engagement surface having a second contact angle in that is different from the first contact angle.
Clause 44, the device of clause 38, further comprising a cover covering the one or more protrusions.
Clause 45, the device of clause 38, further comprising a hinge or pivot configured to allow movement of the one or more protrusions to convert between the first configuration and the second configuration.
Clause 46, the device of clause 38, further comprising a lock configured to lock the one or more protrusion in the first configuration and/or the second configuration.
Clause 47, a convertible dental auxiliary device, the device comprising: a tooth-bonding surface configured to be bonded to a tooth surface; and a body region extending from the tooth-bonding surface, wherein the body region comprises one or more protrusions having a first configuration comprising a first contact profile, and a second configuration wherein the contact profile has a different shape and/or different orientation relative to the first configuration, wherein, in the first configuration the contact profile is configured to engage with a receiving region of one or more patient-removable dental appliances when the one or more dental appliances is worn on a patient's teeth, further wherein the body region is convertible between the first configuration and the second configuration by moving the one or more protrusions relative to the tooth bonding surface.
Clause 48, the device of clause 47, further comprising a pivot joint between the protrusion and the tooth-bonding surface configured to change the orientation between the first configuration and the second configuration.
Clause 49, the device of clause 47, wherein, in the second configuration the contact profile comprises an arm or hook extending from the body region.
Clause 50, a convertible dental auxiliary device, the device comprising: a tooth-bonding surface configured to be bonded to a tooth surface; and a body region coupled to and extending from the tooth-bonding surface, wherein the body region comprises an engagement surface configured to engage with an orthodontic appliance (e.g., aligner, retainer, palatal expander, etc.) and a lock, wherein the body region is convertible between a first configuration, in which the engagement surface has a first orientation relative to the tooth-bonding surface, and a second configuration, having a second orientation relative to the tooth-bonding surface, by disengaging the lock and moving the body region relative to the tooth bonding surface, and re-engaging the lock.
Clause 51, the device of clause 50, wherein the lock comprises a bias, e.g., a spring.
Clause 52, the device of clause 50, wherein the interface between the tooth-bonding surface and the body region comprises a sawtooth surface.
Clause 53, the device of clause 50, wherein the second orientation of the engagement surface has a greater angle relative to the tooth-bonding region than the engagement surface in the first orientation.
Clause 54, the device of clause 50, wherein the engagement surface is configured to be rotated in the plane of the tooth-bonding surface in the second orientation relative to the first orientation.
Clause 55, the device of clause 50, further comprising a shim that is configured to be coupled between the body region and the tooth-bonding surface in the second orientation.
Clause 56, a convertible dental auxiliary device comprising: a tooth-bonding surface configured to be bonded to a tooth surface; and a first body region lockable coupled to and extending from the tooth-bonding surface, wherein the first body region comprises a first engagement surface configured to engage with an orthodontic appliance; and a lock, wherein the lock is configured to secure the first body region onto the base; and a second body region configured to be swapped for the first body region by unlocking the lock, removing the first body region and securing, by the lock, the second body region on the tooth-bonding surface, wherein the second body region comprises a second engagement surface that has a different orientation relative to the tooth-bonding surface than the first body region.

What is claimed is:

1. A convertible dental auxiliary device, the device comprising:
a tooth-bonding surface configured to be bonded to a tooth surface; and
a body region extending from the tooth-bonding surface, wherein the body region comprises a channel extending at least partially through the body region and a channel opening configured to receive an orthodontic force accessory within the channel, wherein the body region is convertible between a first configuration and a second configuration, wherein the channel opening is closed in the first configuration, and wherein the channel opening is open in the second configuration.

2. The device of claim 1, wherein, in the first configuration, the body region forms an engagement surface for engaging a receiving region of a dental appliance when the dental appliance is worn on a patient's teeth, wherein the dental appliance comprises a shell having one or more cavities for receiving one or more teeth of the patient.

3. The device of claim 1, wherein, in the first configuration a removable material is held within the channel.

4. The device of claim 1, further comprising a cover configured to cover the channel opening in the first configuration.

5. The device of claim 4, wherein the cover is removable from the channel opening.

6. The device of claim 4, wherein the cover is hinged to the device.

7. The device of claim 4, wherein the cover comprises a penetrable material configured to be pierced to provide access to the channel.

8. The device of claim 1, wherein, in the second configuration, the orthodontic force accessories comprise a power arm that is configured to be secured within the channel.

9. The device of claim 1, wherein the channel comprises a vertical slot.

10. The device of claim 1, wherein the channel comprises a horizontal slot.

11. The device of claim 1, wherein the channel is one of a plurality of channels.

12. A system, the system comprising:
a convertible dental auxiliary device comprising:
a tooth-bonding surface configured to be bonded to a tooth surface; and
a body region extending from the tooth-bonding surface, wherein the body region comprises a channel extending at least partially through the body region and a channel opening configured to receive an orthodontic force accessory within the channel, wherein the body region is convertible between a first configuration and a second configuration, wherein the channel opening is closed in the first configuration, and wherein the channel opening is open in the second configuration;
one or more dental appliances each comprising a receiving region that is configured to engage with an engagement surface of the body region when the body region is in the first configuration; and
an orthodontic force accessory that is configured to be received by the channel of the convertible dental auxiliary device in the second configuration.

13. The system of claim 12, wherein, in the first configuration, a removable material is held within the channel.

14. The system of claim 12, further comprising a cover configured to cover the channel opening in the second configuration.

15. The system of claim 12, wherein the cover is removable from the channel opening.

16. The system of claim 12, wherein the cover is hinged to the device.

17. The system of claim 12, wherein the cover comprises a penetrable material configured to be pierced to provide access to the channel.

18. The system of claim 12, wherein the channel comprises a vertical slot.

19. The system of claim 12, wherein the channel comprises a horizontal slot.

20. A convertible dental auxiliary device, the device comprising:
a tooth-bonding surface configured to be bonded to a tooth surface; and
a body region extending from the tooth-bonding surface, wherein the body region comprises one or more protrusions forming a first contact profile in a first configuration, and a second configuration comprising a second contact profile that is different from the first contact profile, wherein the first contact profile is configured to engage with a receiving region of one or more patient-removable dental appliances when the one or more dental appliances is worn on a patient's teeth,
further wherein the body region is convertible between the first configuration and the second configuration by moving the one or more protrusions relative to the tooth bonding surface.
